(19) United States
(12) Patent Application Publication
(10) Pub. No.: US 2007/0079236 A1
(43) Pub. Date: Apr. 5, 2007

(54) Multi-form design with harmonic composition for dynamically aggregated documents

(75) Inventors: Evan Schrier, Fall City, WA (US); David H. Salesin, Seattle, WA (US); Charles E. Jacobs, Seattle, WA (US); Geraldine G. Wade, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/343,351

(22) Filed: Jan. 31, 2006

Related U.S. Application Data
(60) Provisional application No. 60/723,467, filed on Oct. 4, 2005.

(51) Int. Cl. G06F 17/00

(52) U.S. Cl. 715/517; 715/518

(57) ABSTRACT

An architecture employed to create a high quality document, which is a document that looks good given the type(s) of content to be displayed in the document and the size/dimensions of the displayed document. The architecture can utilize high level templates that broadly define layout constraints to adapt the content to multiple sizes and dimensions with a wide variety of content in a wide variety of formats. Additionally, high level descriptions of high quality documents can be translated into low level constraints for use with an AGDBL system, dramatically reducing the number of templates required by that system while at the same time increasing the functionality of the templates and the ease with which the templates can be created and maintained.

### CROSS-REFERENCE TO RELATED APPLICATIONS

This application claims the benefit of U. S. Provisional Application Ser. No. 60/723, 467, filed Oct. 4, 2005, entitled “ADAPTIVE DISPLAY OF WEB-BASED AGGREGATED DATA/ADAPTIVE GRID-BASED DOCUMENT LAYOUT SYSTEM.” The entirety of this application is incorporated herein by reference.

### BACKGROUND

Commercially printed publications, such as newspapers and magazines, significantly use grid-based page layouts and designs. In the 1920s and 1940s, designers Mondrian and Le Corbusier created ordered grid-based design systems for printing various types of document content. These grid-based design systems were further improved in Switzerland after World War II and, in the 1950s and 1960s, rapidly spread throughout the world as the standard for commercial publications. Today, grid-based design systems remain universally implemented in a variety of publication systems.

Several successful software systems exist that support grid-based page designs. Products such as MICROSOFT PUBLISHER offered by Microsoft Corporation of Redmond, Wash., QUARKXPRESS® offered by Quark, Inc. of Denver, Colo., and ADOBE PAGEMAKER® offered by Adobe Systems Incorporated of San Jose, Calif. have become the industry standards for commercial publishing and desktop publishing. Although these software systems are adequate for their intended purpose, the actual mapping of page elements, such as text, images, and sidebars, to grid positions within a document layout remains a manual process. Typically, grid-based document layout is customized for one specific page size, such as an 8½-by-11 inch sheet of paper. There is, however, no obvious way for these customized layouts to adapt to a range of page sizes and other viewing conditions in a graceful manner (i.e., also referred to herein as “document-reflow”).

Because grid-based document layout account for both static fixed size and manual process, grid-based design systems generally do not support “document-reflow.” Systems that do support the reflowing of document content, such as Microsoft Word and hypertext mark-up language (HTML), typically consider the document content as a single, one-dimensional flow that snakes from one page to the next. Thus, these types of systems can lose the original grid-based document layout. Such a difficulty can arise as well with systems that utilize multiple orientations with different form factors.

The difficulty of generalizing grid-based designs explains the generally inferior nature of on-screen layouts compared to similar printed layouts. As screen resolutions of display devices begin to match the resolution quality of a printed page, there arises a need to easily and automatically adapt grid-based document designs to arbitrarily-sized electronic displays. “Harmonic composition” can be used to define a set of rules and constraints applied to the placement of objects, such as (but not limited to) text and image within the grid based system so as to keep relationship and proportion of elements for optimal viewing and readabilty for dynamically aggregated documents. This can be a unique factor in the development and design of an effective high quality adaptive layout. This difficulty is arguably one of the greatest remaining impediments to creating on-line reading experiences that rival those of ink on paper. On-screen reading experience may eventually surpass the experience of reading paper, because computers provide a multitude of opportunities for customization and style, as well as capabilities such as animation and interactivity.

Adaptive grid-based document layout requires flexible pagination for the mapping of document content to a set of discrete pages. The discrete pages may be subject to various constraints such as the sequential ordering of words in a stream of text, the finite capacity of the pages, and the dependencies between the content within a document (e.g., textual references to figures or tables). Finding a desirable pagination is often difficult when one or more additional types of content, such as figures or tables, are involved.

To acquire optimal pagination, a measure of success must be defined for each of the appropriate sets of discrete pages. Pagination has the “optimal subproblem” property and, therefore, is solvable by dynamic programming. Any optimal solution of n pages would inherently contain an optimal solution of n-1 pages. Typically, a dynamic programming paginator starts with an empty solution set and incrementally adds and solves a subproblem (e.g., a subset of discrete pages) to find an appropriate set of discrete pages. Additionally, the dynamic programming paginator keeps a table of each subproblem's score (e.g., a measure of success based on a predetermined metric) and a pointer back to the preceding subproblem in the optimal solution. A new subproblem is evaluated by scanning the table for the preceding subproblem with the best score that may properly precede the new subproblem. Accordingly, the dynamic programming paginator evaluates each of the possible predecessors of each new subproblem. Unfortunately, there may be a significant number of predecessors of each new subproblem to evaluate, with a vast majority not even qualifying as valid predecessors of the new subproblem. Therefore, the dynamic programming paginator inefficiently conducts evaluations of unusable predecessor subproblems and, thus, slows down the speed of pagination.

Moreover, in today's computer environment there is a rapid expansion of devices and displays in both form and aspect ratio. Content and information are poured into tiny wrist displays, portable hand-held devices, digital fabrics, work stations and even large wall mounted displays. As part of this trend the personal computer has emerged as an important reading medium. In fact, reading onscreen has become a principal form of gathering information in our society today.

However, many of our current methods of designing documents for the web, or these devices with dramatically different display sizes and shapes, fall short of efficiently utilizing the new dynamic real estate offered by the many varieties of displays. Most web formats do not perform well over multiple displays. This is in part due to the influence of static print based design media on readability for the screen. Vast bodies of information are available in print form, and the advantage and importance of good document design is well known in the print world as aiding communication, readability and marketability because it attracts and holds viewers' attention. While good quality, grid-based design is commonplace in print, it is not prevalent in online documents. Accordingly, new multi-level design concepts need to be explored to take account of the display characteristics of screen size, ratio and orientation.

The internet makes it very easy to assemble documents out of information from many disparate sources and display it together on a single screen. Search engines and news aggregators do this and display their results as an HTML web page. However, it would be preferable to instead display these results in a well designed, attractive way that rivals the quality designs commonly seen in print. Earlier work made it possible to display grid-based designs that adapt to different viewing conditions, but the designs didn't always transfer well to different content and were prohibitively difficult to produce.

Thus, previous work allowed users to design grid-based document layouts which adapt to different window dimensions, but the document layouts were specified in a low level language that was difficult to create and maintain. For example, a “style” could be designed to be a collection of constraint-based templates, each of which can display a certain collection of content at a designated range of screen sizes. As a document window was resized, the template's constraint system resizes each display element until a threshold is crossed, at which point another template was used. However, the objective of previous systems was for document styles to be re-usable for multiple documents. While this was true to an extent, in practice it was found that many layouts would not look good if the figure dimensions were significantly different than ones used in the original design. Designing a robust style that could handle any combination of visual elements required huge numbers of templates to be designed, one for each possible combination of elements and element variations.

Accordingly, the previous adaptive document system has allowed designers to build documents that adapt to different screen sizes and formats, but suffered from two critical problems. First, it was very difficult to work with the actual document layouts, both to create new designs and to modify existing designs. Second, document layouts did not adapt very well to disparate selections of content without being modified by designers or editors prior to publication.

Layouts in printed media have the benefit of designers and editors who customize the final product by altering both the layout and the content. A single, static design template is unlikely to look very good for different types of content where titles or headlines are different lengths and graphics are different dimensions, even though most of the design elements on the page may be the same. One of the main challenges in multi-level design of this nature is to maintain quality layouts, since there is no editor making sure everything in a layout looks good and customizing things when necessary, the designs should be able to accommodate multiple ways to display content and distinguish which method is best at any time.

### SUMMARY

The following presents a simplified summary of the claimed subject matter in order to provide a basic understanding of some aspects of the claimed subject matter. This summary is not an extensive overview of the invention. It is not intended to identify key/critical elements of the invention or to delineate the scope of the invention. Its sole purpose is to present some concepts of the claimed subject matter in a simplified form as a prelude to the more detailed description that is presented later.

The claimed subject matter disclosed and claimed herein, in one aspect thereof, comprises an architecture that can facilitate easily designing and displaying rich, grid-based designs and/or high quality layouts that adapt to many different viewing conditions and content selections. To the accomplishment of the foregoing, templates can be employed that describe at a high level the constraints of the layout. These templates can be much easier to produce and maintain, while increasing the flexibility of the layouts, allowing them to better adapt to disparate content. As well, the applicability of the architecture can be increased over previous systems (e.g., “Adaptive Grid-Based Document Layout” (AGBDL), Jacobs, et al. 2003) by broadening the types of content which can be displayed, particularly focusing on content aggregated from a variety of sources on the internet.

In accordance with an aspect of the claimed subject matter, templates can be defined with high level constructs that are easy to understand and use. Accordingly, the task of designing and/or maintaining the templates can be practical for graphic designers who may not have an extensive technical background. Additionally, the resulting designs can be easily understandable and maintainable by other designers, even those who did not help to create the template. The templates created can be employed with both static documents and dynamic documents obtained from a variety of web-based sources. The templates can be employed for multi-level design layouts as well, that, for example, can produce documents with multiple layers of content.

In accordance with another aspect, the resulting document layouts can be high quality layouts (e.g., layouts that “look good”), and retain their visual appeal at different display sizes while employing disparate types of content. High quality layouts can be designed such that they do not compromise semantic flow, brand identity, image and text correlation, advertising themes and the like.

In accordance with another aspect of the claimed subject matter, the templates can be flexible enough to handle a wide variety of content that may be found in an aggregated document without requiring a large number of templates to be designed and maintained. Rather, a single template can define a number of possible configurations of elements and/or content, greatly reducing the number of templates needed to provide flexible designs. Furthermore, the templates described at a high level can be translated into the low level constraints employed by other systems. The architecture can supply constraint systems automatically to implement common behaviors in adaptive documents, rather than requiring each designer to code them by hand.

Moreover, the architecture can allow graphic designers to easily design high-quality document layouts that adapt to different screen sizes, even when the precise content to be displayed is unknown. Additionally, the concept of a document can be expanded to include references to external sources that will likely not be in a uniform format. Accordingly, the architecture can make it easy to produce multi-level design architecture based on high-quality, grid-based adaptive designs with enough flexibility to handle content that is aggregated from multiple sources, and can be unknown at design time.

To the accomplishment of the foregoing and related ends, certain illustrative aspects of the claimed subject matter are described herein in connection with the following description and the annexed drawings. These aspects are indicative, however, of but a few of the various ways in which the principles of the invention can be employed and the claimed subject matter is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a system that facilitates adapting a document layout that can be displayed at multiple sizes and dimensions with a wide variety of content.

FIG. 2 illustrates a block diagram of a system that facilitates the creation, modification and/or storage of a template.

FIG. 3 illustrates a layout engine that generates a high quality layout based at least in part upon semantic flow, brand identity, image and text correlation, and/or advertising themes.

FIG. 4 illustrates a system that facilitates adapting a document layout that can be displayed based upon the dimensions of an output device.

FIG. 5 illustrates a system that creates a high quality layout based upon a template specified with high level constructs, and translates the layout into low level constraints a low level engine can use to create the high quality layout.

FIG. 6 illustrates a system that selects a template and/or to arranges content on a layout in order to produce a high quality layout.

FIG. 7 illustrates a layout engine that employs Extensible Stylesheet Language Transformation (XSLT) to translate from a source format.

FIG. 8 illustrates an exemplary flow chart of procedures that facilitates for arranging content to create a high quality layout.

FIG. 9 displays a block diagram representation of an adaptive grid-based document layout environment.

FIG. 10 displays a block diagram representation of a computing environment and computer systems thereof which the present invention may utilize.

FIG. 11 displays a block diagram representation of a document layout including adaptive layout styles and templates.

FIG. 12 displays a block diagram representation of an adaptive template.

FIG. 13 displays a block diagram representation of a document content including content streams.

FIG. 14 displays a block diagram representation of a content stream including content items.

FIGS. 15A-15B display a flowchart representation of a method of applying document content to templates.

FIGS. 16A-16C display flowchart representations of a method of flowing content into elements within the document layout.

FIGS. 17A-17C display flowchart representations of a method of self-sizing elements within the document layout.

FIG. 18 displays a flowchart representation of a method of scoring a template based on how well the document content fits the template.

FIGS. 19A-19D display a flowchart representation of a method of optimally paginating document content into an adaptive grid-based document layout.

FIG. 20 illustrates a schematic block diagram of an exemplary computing environment.

### DESCRIPTION OF THE INVENTION

The claimed subject matter is now described with reference to the drawings, wherein like reference numerals are used to refer to like elements throughout. In the following description, for purposes of explanation, numerous specific details are set forth in order to provide a thorough understanding of the invention. It may be evident, however, that the claimed subject matter may be practiced without these specific details. In other instances, well-known structures and devices are shown in block diagram form in order to facilitate describing the claimed subject matter.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

As used in this application, the terms “design” or “layout” refer generally to how content is arranged within a document. As used herein design and layout can be substantially interchangeable. For example, both a document design and a document layout can refer to how content is arranged in the document.

As used in this application, the phrase “high level” generally refers to a programming language or programming constructs that are more user-friendly than low level languages or constructs, and may be to some extent platform-independent. High level constructs can provide abstractions to low level operations to avoid the complexity that is otherwise necessary to implement the operations. Generally, an assembly language, as well as pure Hyper Text Markup Language (HTML) and other “loose” coding formats are consider to be low level, whereas the output format after applying an Extensible Stylesheet Language Transformation (XSLT) is considered to be high level.

As used herein, the term “high quality” means that a resulting output is determined to look good given the present display dimensions and the present content. High quality can refer to a layout or design or a specific location within the layout for which specific content will be inserted. For example, a high quality layout is one that is determined to look good at the present display dimension with the present content whereas a high quality location is a location for which specific content can be introduced while maintaining the high quality character of the overall layout or design. It is to be appreciated that high quality character of a layout or location may require meeting additional conditions as well, such as not compromising semantic flow, brand identity, image and text correlation, advertising themes and the like. It is also to be understood that these additional conditions can be based upon considerations described infra, such as non-rectangular templates and elements, column balancing, unbreakable paragraphs and atomic sub-documents, and interactivity.

The embodiments described herein relate to a system for adaptive display of web-based, aggregated data, and template improvements for an Adaptive Grid-Based Document Layout system. A system for aggregating internet content and displaying it using the Adaptive Grid-Based Document Layout (AGBDL) system is provided that allows data to be displayed in a wide range of high-quality visual formats that can adapt automatically to different display sizes. The system can use any of a number of content sources including but not limited to RSS news feeds, internet search engine results, internet news aggregator back-ends such as MSN Newsbot, and content “scraped” directly from content web-sites such as newspapers and magazines. This can be done by expanding the notion of a document, as described in the original AGBDL work in also detailed infra.

The subject architecture can support documents that consist of a number of separate documents and that can be arranged into a multi-level hierarchy of parent-documents and embedded sub-documents. Each component document can be comprised of a combination of native and external sources that can be translated at load time into the native document format of the system, either through an XSLT translation that can be specified for each individual source, or through a helper program that might be a web-scraper or some other data gathering or processing agent. External sources can be specified at multiple levels in the document. An external source can be loaded as an entire document (top-level or sub-document), as a particular content stream in a document, or as a single content item in a particular content stream. Furthermore, an external source can be included in a document entirely or in part. For instance, a single content stream can be selectively loaded from a given source after translation.

In support of this, the document schema has been expanded to allow an AGBDL document to reference external sources in the ways described above. When a document is parsed and loaded, any sub-documents or other external content specified can be translated (if necessary) and then recursively parsed and loaded as well. Sub-documents are defined as complete AGBDL documents on their own, referencing their own set of display templates that are used as sub-templates in the enclosing document. At display time, the sub-document is passed a screen region in which the document should be rendered. The sub-document can recursively paginate and then lays itself out in the given region as if it were a top-level document in the given window. The sub-document can be distinct from other external content that is loaded as data in the enclosing document because the latter can be displayed in the parent document using the parent document's templates like any other content.

Regarding adaptive templates in the AGBDL system (described in detail below), expansions in connection with the following are provided: High-level template design, extended template adaptability (templates adapting to content), and template parameters and outputs. All three of these categories can facilitate the authoring and maintaining of “document styles”. Styles can be defined as a collection of templates that together cover the range of layouts in which a document may be rendered.

High-level template design can allow constraint-based templates to be specified using high-level constructs that are interpreted by the system to generate the low-level details, including each display element's dimensions and location as well as the individual constraints that control the element's display features, relationships to other display-elements, and adaptive behaviors.

Conventionally, such as in the AGBDL system, the templates needed to be specified by writing XML code that described each display-element, constraint, and attribute occurring in each template. The template authoring tool made it (arguably) easier to write and modify templates via a GUI interface, but the author was still required to specify all of the same details via this other method.

The subject innovation can allow document specification using high level constructs such as adaptive column grids and relative relationships between elements. A column grid can be defined using combinations of proportional and absolute column widths, and rules can be specified controlling which columns are instantiated at any given page width. Display elements can then be placed spanning one or more of these columns or portions of these columns, which can then be related to other elements through, for example, “over” and “under” assignments. A single statement can specify or imply a collection of parameters from which many low-level constraints are generated automatically at load-time. Other parameters can be specified establishing attributes of elements such as margins and padding that are used to generate additional constraints.

Documents or pages often contain collections of similar display elements, such as multiple columns of text, which share many parameter values. Aspects of the claimed subject matter can allow an element to be described once and then instantiated multiple times. Each instance can have a subset of its details over-ridden, such as its location information. Additionally, the description language is reorganized so that all constraints relating to a particular element can be included in the element description making it easier for a user to understand and maintain the template.

Extended template adaptability can allow each individual template to cover a wider range of display dimensions and document content. Previously, each template had a fixed set of display elements, requiring a specific set of content, and the elements would be adapted through the constraint system to cover a range of page dimensions. Each different content assortment, such as the number of figures on the page, would require a different template. A figure with a landscape aspect ratio would use a different template than a figure with a portrait aspect ratio. Handling multiple figures on a page with potentially different aspect ratios or resolutions would require increasing numbers of templates to handle the possible combinations of figure types appearing in various orders in the content streams. A single template would also have a fixed number of columns in the original system, requiring new templates handling all of the possible permutations of figure types for each number of columns a page may possess. The total number of templates required for a flexible “style” grew exponentially as the possible dimensions in which a template adapts increased, making the creation of a broadly applicable style cumbersome and the maintenance of it very difficult.

The subject template definition has a number of new features that address these issues. Optional elements can allow different content selections to be handled by a single template. Elements can be combined into “Or” groups that can allow a template to instantiate only one element from a set of possible choices each time the template is used. Or groups can use one of several algorithms for deciding which element to choose in a given layout, including best-fit, first-fit, first-good-fit and similar algorithms.

Additionally, the new templates can now have a variable number of columns. The column definition described above can include rules for the inclusion of adaptive columns based upon specific page thresholds or thresholds can be calculated by the components of the architecture based upon minimum column widths. Column priorities can be specified that control which columns are instantiated at particular page sizes. Columns that are not used at a particular page width can be collapsed to zero width by the constraint system so that elements that span them are either reduced in width or eliminated completely at that page size. Together, the optional elements and adaptive column grids can reduce the number of templates and the associated maintenance dramatically.

Another extension to the template system can allow parameters to be passed back and forth between parent templates and the sub-templates laid out inside them. The parameters and returned values can be placed in the constraint cache of the receiving template so they can be referenced by elements like any other constraint value. These parameters can be used, for exampl&, to set the number of columns in a sub-template, flag the inclusion or exclusion of optional elements, or control the way figures are displayed in the child. The parameters passed to a sub-template may be immediate values or may be constraints in the parent template's system that can be evaluated at call time.

As well, a style-sheet can be passed as a parameter to a sub-template so a parent document can directly control many of the typesetting details used in the child. Returned parameters can inform the parent template of otherwise hidden details of the child's layout, such as where the top or bottom of a figure lies, or where a headline or title ends. The parent can then align other display elements to features in a sub-template or ensure that two unrelated figures in separate sub-templates are not placed side-by-side.

As will be appreciated by those skilled in the art, there are other improvements that add to the power of the templates, particularly for displaying hierarchal compound documents as described above. For instance, “And” groups allow a collection of elements to consume from a single content atom allowing greater flexibility in laying out and organizing documents. This can allow, for example, a feature photograph to be pulled out of an individual news story and displayed on the front page of a newspaper in a separate element than the rest of the story. Another feature can pass the Graphical Display Interface (GDI) region of the hosting element to the sub-template being used in the element, rather than the rectangular bounding box passed by previous systems. This aspect can allow the sub-template to flow its text around overlapping elements in the parent template or to choose an un-occluded element from an OR group to display a picture.

As described supra, other embodiments can provide for high-level constructs for template specification to facilitate more powerful ways to describe desired behavior of the column grid, such as a specific range of desired sizes for each column, including a collection of fixed-size choices. In addition, priorities can be specified for resolving over-constrained and under-constrained situations, using automatically generated margins for example. Embodiments can support automatically-generated vertical grids similar to the columns but following different rules and heuristics, and adaptive sub-grids dividing individual grid-columns, and additional top-level grids to allow layouts with different collections of elements controlled by different grids. Individual elements can be instantiated multiple times and it is contemplated to be able to build a group of elements that can all be instantiated together multiple times.

Specifying a consistent constraint system in the presence of optional elements (and OR groups of elements) can quickly become very complex and tricky, what is also contemplated is to develop constructs to work out the correct system and automatically build it into a template given a description of the desired result.

Additionally, it is also contemplated to add more interactivity to Adaptive Display Layout (ADL) documents by allowing end users to resize individual display elements as they view the content, or add new data into an element, as well as to extend the adaptive-column-count behavior to use more sophisticated methods to choose which columns to include at a given size, based upon the content present. This could involve rendering each possible selection of columns and choosing the best based upon a layout score.

As briefly detailed supra, according to one aspect, the claimed subject matter can extend the previous AGBDL document system in three general ways. First, the template system was improved, making the templates more powerful and requiring far fewer templates to cover an even wider range of content, and at the same time making the templates easier to write and maintain. In addition, the document definition was expanded to allow a document to gather content from multiple locations and for individual documents to be assembled into hierarchies of parent and child documents. Finally, the layout engine (e.g., the low level engine in the AGBDL system) was updated to provide support for new features often specific to the new domains. These extensions and other aspects of the claimed subject matter will now be described.

Templates

There are three primary aspects of the templates. First, the templates can be specified using a high-level language making templates easier to author, understand and maintain. Second, the templates can be adaptable to the available content, rather than requiring separate templates for every possible variation, and combination of variations of content in a single layout. Third, the templates can have the capability of extending over a larger range of screen dimensions decreasing the number of similar templates which must be written and maintained.

Templates in the AGBDL system were very difficult to write and to understand because they were written in a very low-level language. Each individual constraint was specified explicitly and many constraints were required for every element on a page. Constraint systems for sophisticated adaptations, such as a variable number of columns, were prohibitively difficult to write, and deciphering another author's templates was too hard. The template design tool provided a GUI for template design, but it mostly provided only low-level support, still requiring most constraints to be independently set. Furthermore, its output was very difficult to understand and edit, making it difficult to customize a design beyond the capability of the tool.

According to one embodiment, the claimed subject matter employs templates that capitalize on the native strengths of high level constructs, thus including more powerful building blocks in the template language itself. High-level primitives in the new language can be compiled into basic structures when the template is loaded by the system, or they can be read by the updated layout engine directly. Many parts of the constraint system can be inferred from the new primitives and are automatically generated. The system can also automatically generate complicated constraint systems for well known, useful tasks.

High Level Template Description

Both the original AGBDL system and the claimed subject matter can define templates as Extensible Markup Language (XML) documents. In the original system the template description was organized into sections. All elements were described by <element> nodes inside the parent <elements> node, and all constraints were described by <constraint> nodes inside the parent <constraints> node. High level templates can retain the two sections, and can also allow an author to alternatively define a constraint inside of any element node. This flexibility can allow the template to group constraints which describe a specific element directly with the element, and place global constraints in the general section.

Rather than require authors to specify each constraint individually, a number of child nodes can be defined, which can be placed under element nodes to implicitly define several individual constraints applying to the parent. For instance, margins and padding can be specified for an element with single nodes containing some of the attributes shown in the examples, infra:

<margin all=”5” sides=”5” ends=”5” left=”5” right=”5” top=”5”
bottom=”5” />
<padding all=”page.default.padding” left=”page.width * 0.05”
/>

Specific assignments will typically always override more general ones. Any value that is not defined by an attribute can be assumed to be zero. The author can assign attributes to immediate values or to expressions referencing other constraints. The constraints controlling the sizing and placement of an element can be specified with a single location node, again using a subset of the possible attributes. If a node is under-constrained after parsing the location node, an error is usually generated.

As illustrated in the following example, “over” and “under” attributes can be employed to assign elements based on the position of other elements. For example, the “over” attribute aligns the top of the current element with the bottom of the named element, and the “under” attribute aligns the bottom of the element with the named element's top.

<location left=”page.left” right=”page.left+column.width”
top=”header.bottom” height=”300” />
<location center=”page.center”” width=”250” under=”header”
over=”footer” />

It is common to divide a document into a coarse grid of columns. As a document's width changes there are only a few likely behaviors which most columns will use to adapt. For example, the columns might all grow equally as the page widens, or shrink equally as the page narrows. The columns might also grow and shrink according to some fixed proportions. Alternatively or additionally, some columns might remain a fixed width while other columns resize or the extra width might be absorbed into gutters and margins around the columns. It is to be appreciated that the template language can contain tools to define grids that adapt using combinations of the behaviors listed above, or even other likely or desired behaviors. Aspects of the claimed subject matter can automatically generate the constraint system necessary to implement the defined behaviors for the columns. For instance, the template designer can create a <grid> node which defines the number and default behavior of the member columns, and then any number of column nodes can be created under the grid node which can define alternate behaviors for individual columns, as in the example below:

```
<grid id=”maingrid” columns=”4” type=”proportional”
margin=”10”>
    <column n=”2” proportion=”3.0” />
    <column n=”4” type=”fixed” width=”200” />
</grid>
```

The above grid node can define a column grid of four columns. The first three columns are defined to grow proportionally with the page, and the second column is three times wider than each of the other two. The fourth column always remains fixed at 200 pixels width. When the grid node is parsed, constraints defining grid lines named, e.g., “maingrid. grid0” through “maingrid. grid4” can be created. The constraint system to locate each of the grid lines as the page width changes can be automatically generated. Further constraints can be made by defining columns relative to the grid lines named, e.g., “maingrid.column1.right”, “maingrid.column1.left”, etc. A template author can reference these names directly in constraints defining elements, or else can place a “column” attribute in location nodes that implies left and right constraints as is done in the latter two of the following examples.

<location left=”maingrid.column2.left”
right=”maingrid.column2.right” top=”page.top”
bottom=”page.bottom” />
<location column=”maingrid.column1” top=”page.top”
bottom=”page.bottom” />
<location column=”column2-column3” under=”masthead”
height=”300”/>

The dash (“-”) in the second location column example indicates here that the element spans both columns 2 and 3. If there is only one grid defined, the name prefix can be left off of column and grid names, as is done in the second example above and they will be assumed to refer to the single grid. Spans of columns can be used in addition to individual columns. Additional constraints can be created for each column which can be used in locating elements. These can include, but are not limited to “column.width” and “column.center” as well as the fractional column lines “column.1third”, “column.2third”, “column.1quarter”, and so on.

It is typical to have many similar elements on a page that share many if not most properties in common, such as text columns on a multi-column page, divider graphics and figure elements. The element definitions can be reused by placing multiple <location> nodes under a single <element> node. Each location node can create a new instance of the parent element that is sized and located with the additional node's attributes. Element names can have a 1-based index, assigned in the order in which the location node appears, appended to their names so that instances can be distinguished in constraint expressions.

When constraints are defined in an element with multiple instantiations, it is often necessary for each instance to use a unique name for each constraint. Macros can be made available to facilitate the multiple instantiations. The string “!THIS!” appearing in a constraint name or expression can evaluate to the name of the instance being processed at the time. “!LAST!” can evaluate to the previous element, which makes it easy to chain or stack the elements. Starting a name with a period (“.”) generally assumes the name of the current instance precedes the period.

Using multiple location nodes can be a concise and efficient way to make duplicate elements, but it can also be useful to allow variations in some of the instances. For example, some otherwise identical elements might have different z-layer (described below) requirements or may consume from different content streams. For this reason, any property defined in the element node can be overridden in a location node. Properties which consist of a single value, such as layer or style ID can be overridden by setting an attribute on the location node. More complicated properties, such as preconditions, can be overwritten by placing a precondition node under the location node. The following example shows an element instantiated three times with properties overwritten on the second two.

```
<element id=”text.column” layer=”2” recomputeHeight=”true”>
    <content content-src=”body” />
    <style id=”normal” />
    <padding sides=”10” ends=”5” />
    <margin all=”8” />
    <location column=”column1” under=”header”
height=”page.bottom-!THIS!.top” />
    <location column=”column2” under=”header”
height=”page.bottom-!THIS!.top” layer=”3”/>
    <location column=”column3” under=”header”
height=”page.bottom-!THIS!.top” >
        <padding all=”0” top=”5”/>
    </location>
    <constraint var=”!THIS!.area” value=”!THIS!.height *
!THIS!.width” />
</element>
```

In the AGBDL system it was common to create a new family of templates for each count of columns supported on a single page. A family of templates would be selected by a range of page widths. A one column family of templates might be used for narrow pages and when the page width increased beyond a given threshold then the system would switch to a two column family. Each family would contain multiple templates covering different combinations of and locations for content on the page. Often most visual elements in these families are the same with the exception of the number of columns.

This similarity between families can leveraged by defining an adaptive grid that not only resizes columns as the page width changes, but can also vary the number of columns on the page. This can be achieved by placing an <adaptive> node beneath a grid definition node in a template. When the adaptive node is present the column count in the grid node can serve as a maximum number of columns. A rule can be placed in the adaptive node to determine how many columns are activated at any given page width. Rules can be specified, for example, either minColumnWidth or maxColumnWidth. The minColumnWidth rule can instruct the template to use the maximum number of columns, which typically all have a standard width of at least a given threshold. Since columns may have different proportional sizes, the actual size of each column can be divided by the column's proportion value when checking for minimum and/or maximum width.

The author can give any or all columns a priority that controls the order in which columns are dropped when the page is not wide enough to include all of the columns. A default priority can be applied when no priority is specified. For example, a default priority can be set to drop columns from right to left. To assign different priorities the author can include a priority attribute in the grid definition node with a comma-delimited list of priority values to assign to columns from left to right. Alternatively, the author can include a priority attribute in the column definition nodes of the grid definition. The priority is typically an integer value. For a given page layout, generally only columns with a priority value less than or equal to the number of active columns are included.

When adaptive columns are dropped from an instantiation of the template, the constraint system will generally collapse the column to zero width. Elements which have a zero width at layout time typically will not consume content or contribute to the template score. If an element spans multiple columns, the element will most likely only appear to span those columns that are active in any given layout.

Sometimes a designer would like to place an element in the left- or right-most column of a page with adaptive columns. To make this easy, location nodes can recognize special keywords in the column attribute, for example “leftmost” and “rightmost”.

Template Adaptation to Content

Templates can adapt to different configurations of content in a number of ways. AGBDL templates could have a number of preconditions placed upon them which indicate the circumstances, including the precise content requirements, in which each template could be used. In contrast, aspects of the claimed subject matter can allow preconditions to be placed on individual elements in a template in addition to the template as a whole. These element preconditions can allow elements to be conditionally included in a layout depending upon the available content, the viewing conditions, or any other constraints in the system. It may be useful to penalize the template's objective score when an optional element is not used. A special constraint value named, e.g., “element-name.active” can be automatically added to the template's constraint system for every element. The value for element-name. active can be set, for example, to one when the element is included in the layout and zero when the element is not. This constraint value can be tested to consider the presence of any elements in determining the template's objective score. Preconditions set on an element node generally apply to all instances of the element. Precondition nodes can also be placed inside location nodes to add additional preconditions or to override any that are set on the element node.

Element preconditions can allow multiple elements to be individually controlled, but it is often useful to tie the control of elements together, and the elements can be grouped together in several constructs. AND groups can allow several elements to be controlled by a single set of preconditions. Similarly, OR groups can allow a number of layout elements to be defined, only one of which will be included in any instance of the template. Several options and/or algorithms can be supported to decide which instance to use when multiple options are possible. The First-Fit algorithm can use the first element in the group for which all specific preconditions are met. The Best-Fit algorithm can evaluate each group member and uses the element which returns the best objective layout score. The First-Good-Fit algorithm can use the first element in the group that returns a layout score above a given threshold.

It is to be appreciated that the author should use caution when designing templates with optional elements so that the constraint relationships between elements remain valid and produce the desired results whether or not any individual element is present in a given instantiation of a template. Fixed-size elements can retain their dimensions when not instantiated but variable-height elements, those defined with recomputeHeight=“true”, are generally resized to zero height. Constraints defining the boundaries of an OR group can be automatically specified to be the same as the boundaries of whichever member element is selected for each layout.

In accordance with another aspect, a method of adapting templates to content can be provided. This method addresses adapting style characteristics, like typeface and size, to particular content. The style for a block of text can be assigned to a display element when the template is designed. This is typically not a problem, but in some applications, such as displaying headlines on a newspaper page, the visual appearance of the text is critical to its effectiveness. In printed newspapers, a page editor will write headlines to fill the available space, controlling the line breaking and balance. Random headlines placed across columns of differing sizes will often break poorly and/or fail to fill lines, creating poor quality layouts.

In accordance with another aspect of the claimed subject matter, this difficulty can be mitigated by allowing the style in the template to adapt to the available content at display time. The designer can specify a list of possible styles to use with a given element, and the layout engine can try each one, generating an objective score for each. The style that produces the best score will most often be used in the actual layout. However, the same text and template combination will likely choose different styles at different page dimensions. Method for evaluating text layout can be employed to determine the best style. For example, the results of an optimal line-breaker's scoring function, scaled by the font size of the particular style can be utilized. The optimal line-breaker measures the white-space remaining in each line, expressed as a number of character widths. Since the character width usually depend upon the font size, without scaling, larger fonts would tend to produce smaller (better) scores.

Document Representation

Document representation has been expanded to enable the display of data drawn from a wide variety of sources in a high quality fashion. The documents are typically structured identically to the original AGBDL system (discussed below), but with added capabilities.

Since there is no standard format for data on the internet, support for on the fly translation of data sources through, e.g., XSLT. XSLT is a system which translates a source document (generally an XML document) into a new result document by applying a series of rules specified by a translation file. Any arbitrary XML data can be transformed into a document that can then be displayed given a set of appropriate templates that can be referenced by the resulting document. In this way any XML data, web page that has well-formed XML source, or other type of data capable of automatic translation can be loaded directly from the internet if an XSLT translation exists.

A user may specify a translation file as a parameter to our viewer together with a document path or Universal Resource Locator (URL). Alternatively, a user can associate a path or URL prefix with a translation file by placing an entry in a registry, such as an operating system registry. This association can automatically facilitate the XSLT transformation to be applied to the input document whenever the named path or a URL beginning with the prefix is loaded.

Conventionally, one limitation of XSLT translations is that they will only operate on well-formed XML, which many HTML web pages are not. A user may therefore specify an alternative translation program, such as a web-scraper, which can preprocess the specified data before parsing it. In some exemplary applications, both a specialized web scraper and an XSLT translation that operates upon the scraper's output are employed to produce the final document.

The basic structure of a document usually organizes the content into a collection of content streams, which can define ordered sequences of data. Content can be a stream of text, images or compound items, which can contain a collection of sub-streams of their own laid out recursively using sub-templates. A template which displays compound elements generally must supply a list of templates which may be used to lay out the individual streams of the compound element.

It is often useful to have flexibility provided for the manner in which external content is included in a document. Most any content stream in a document can be an external stream that can be loaded from a supplied path or URL. Additionally or alternatively, external references can be specified for individual content items in a single content stream. Virtually all external references can have an associated XSLT translation or other pre-processing agent specified with the link. Most any referenced document can be loaded entirely as a compound item or else individual streams can be extracted from the document. For example, in a news aggregator one might have a collection of streams that contain individual news stories loaded from individual sources, and then a single stream that extracts each of their headlines to build a table of contents.

Although not provided for in the AGBDL system, aspects of the claimed subject matter can introduce the concept of a sub-document, which can be defined as a compound element that includes its own list of display templates. A sub-document can use its own templates when it is rendered rather than templates specified in the parent template. With the inclusion of sub-documents, virtually any document can now be thought of as a hierarchy of parent and child documents.

At each node in the document tree the designer can choose whether the parent or child document controls the layout by supplying the templates. It is not always desirable to have this be an all or nothing choice. Rather, there general methods for influencing the layout of a sub-document from the parent template. One way is for the parent to override the stylesheet of the child template. In an aggregated document modeled after a typical newspaper, it is usually desirable to vary the style of headlines so that they are easily differentiated when they appear side by side. The parent template can ensure this by passing different stylesheets to the elements in which the stories will appear.

Another method for influencing a child document's layout is by parameter passing. Parameters passed to child templates can be entered into the child's constraint system before the template is instantiated. The parameter values can be derived from the parent's constraint system or can be specified directly. These passed constraint values can be used in any number of ways by the child document. They can be included in preconditions for individual elements in the sub-template, or can be referenced by other constraints that control the location and sizing of elements. In other examples we use parameters to suppress the display of large graphics in non-featured sub-documents, but include them when it is displayed as a top-level document or as a sub-document in a featured role. One could also use parameters to align features in a sub-document with features on the parent page or in another sub-document. Designers can similarly specify return values from a sub-template which can be entered into the parent template's constraint system after the sub-template is evaluated.

A feature of sub-documents and compound elements is that they can now be paginated independently. Successive pages of a sub-document can be accessed by turning the pages of the sub-document in place, or can be laid out on successive pages of the parent document. The first method can allow a user to read an entire sub-documented news story on a parent- front page without jumping to an interior page. It can also allow an index to be larger than the space allocated on its page but still have all of its data accessible. Other uses can include, for example, multi-page advertisements or side-bars that reside on a single page of the parent.

Non-Rectangular Templates and Elements

Templates in both the original AGBDL system and the subject innovation are generally defined as rectangles with an origin, width and height. There are many occasions, however, when a non-rectangular element is desired. Such functionality can be accomplished in a single template by layering the elements in a z-order, where sections of higher-layer elements are differenced out of lower-layer elements which they overlap. Elements can be evaluated in descending layer order. Before each element is laid out, the GDI regions of all previously laid out elements can be subtracted from the current element's GDI region. This can be done with a single operation if the regions of the completed elements are accumulated by, e.g., union operations that arrange them into a single region as each is completed. This operation can allow any text in later elements to flow around other overlapping elements, although images will typically still be occluded. Element regions are not usually subtracted directly from regions in sub-templates, however. Instead, the accumulated union of element's regions can be passed to the sub-templates in lower layers, and this parent region can seed the accumulated region in those sub-templates. In this manner text can flow around overlapping elements in higher level templates.

The subtracting of the parent region can handle part of the difficulty of overlapping sub-templates by re-flowing the text, but it is also desirable to avoid occluding images or sub-templates in the child. Thus, there is no easy way to flow images out of the way, so instead it is determined whether an element is occluded (partially or wholly), and reflect that in the objective score of the element. If the template's author chooses to include the element's score in the full template's score, then the template can be disregarded if another template is available with no occluded element. In the alternative or in addition, several locations for the occluded element can be included in one template in a best-fit OR group, in which case a non-occluded location would generally be chosen if one is available.

Occluded elements are detected by differencing out the parent region from the element's GDI region, and then comparing the resulting region to the original. A template author can include an attribute on any element specifying a penalty to be applied to the element's objective score if an overlap occurs when it is laid out.

In another aspect, the parent region can be employed to provide further flexibility in the documents. The parent region can initialize the top-level template of the application window's system clipping region of an operating system. This can allow the system to flow document text around over-lapping windows of other applications on the desktop, and potentially to move occluded images out of their way. The best results can be obtained by inflating any overlapping regions slightly to provide a margin next to any reflowed text.

The procedures described above can allow sub-documents to occupy non-rectangular elements, but this is still not always enough to produce a high quality layout. On a newspaper front page, for instance, one may want to prominently feature a photo from a lead story, and the union of the photo and the rest of the article may not form a convenient rectangle. While a bounding rectangle can always be drawn around the elements, it is often difficult to design a template that can have large or irregular regions subtracted out yet still look as it is intended. This difficulty can be solved more easily by forming an AND group of several elements, wherein all of the elements consume content from a single compound content item or sub-document. This can allow for effectively laying out a sub-document in a region of any arbitrary shape. In the example of the featured story on a newspaper page, it was desired that one element consume from the photo stream and the other element to consume everything else. For this common case, a consumeRemainder attribute can be recognized and employed. A designer can place this attribute on an element in an AND group, which tells the system to use all of the content in that element that was not consumed by other members of the element's group.

Domain-Specific Challenges

In this section, some of the difficulties specific to laying out aggregations of content are described, as well as some of the techniques developed for dealing with these difficulties.

Column Balancing

When laying out multiple stories or articles on a multicolumm layout, there can be many options for how to arrange the stories in relation to one another. One common way to divide a page (or portion of a page) between two stories is to split the page horizontally, placing the second story below the bottom of the first. When using this type of layout, one must distribute the content evenly between the columns allotted for it, so that each column ends at the same vertical position.

In the implementation, this can be achieved via a simple iterative layout algorithm, triggered when a group of elements (and AND group) representing the columns on the page is tagged with the balanceColumns property. Below, is described how this iterative algorithm works for laying out a single story and keeping its bottom as even as possible.

First, page is laid out using, for example, the standard greedy layout method. If the content completely fills the page, then the columns are balanced and this layout can be used as the final result. Otherwise, the total unused vertical space left in the elements to be balanced is measured. This total amount of extra space can

the number of columns to give an initial guess for the amount that each column in the balanced result will be underfilled. Next, this measure of vertical underfill can be subtracted from the bottom of the elements, to yield a cutoff location where we expect the bottom of the balanced text to be. The new bottom of each of the elements can then be set to this calculated cutoff position to perform the layout again. If all the text is consumed and the text is balanced (the last column is allowed to be underfilled by up to 1 line less than the number of columns and still be considered “balanced”), this layout can be used. If, however, the columns fail to be properly balanced, the cutoff position can be adjusted—raised if the last columns is too sparse, lowered if there is not enough room for all the content—by performing the layout procedure again. This procedure can be iterated until converging on a balanced layout.

Finally, the new bottom for the elements can be set to be just below any content laid out in that element. This can prevent elements from having an unpredictable height based on the exact cutoff value the iteration converged on.

Unbreakable Paragraphs and Atomic Sub-Documents

For some situations, it may not make sense to break a piece of content over a page boundary. For example, when the content is merely a one-sentence summary, spanning 2 or 3 lines, it may be preferable to just move the entire piece to the next page. In the specific case of a newspaper-like front page, there may be many small boxes that serve as highlights of the interior or other sections of the newspaper. The contents of these small boxes are typically short summaries of individual stories, as described above. It usually looks much better to avoid splitting these brief summaries across page boundaries. Thus, to accomplish this, either content chunks can be tagged with a property that means “do not split this piece of content across either page or element boundaries.”, or elements can be tagged with another property that means “only accept content items which can be entirely displayed here.” The content in question may be an individual paragraph, or a compound item containing multiple streams of data, perhaps representing a photo and caption or a side-bar.

Interactivity

Electronic documents need not be restricted to mimicking paper documents. Automatically adapting to different screen dimensions is something that paper documents cannot do, but even after the display size is fixed, the document need not assume all the properties of paper documents. For example, content subscribers have long become accustomed to using hyper-links in online documents, but there are other ways a reader can interact with an electronic document as well.

As part of the interactivity, hyper-links can be supported in documents, and links can be targeted to other documents. This includes native documents and documents that can be translated at load time as described in the “Document Representation” section above. A hyperlink may contain a reference to an XSLT translation or another helper program, in addition to the path or URL of the target content. Hyperlinks may also reference URLs that are not readable, in which case a web-browser can be launched to display the content when the link is activated. Finally, hyperlinks can also point to content internal to the document, in which case the page containing the reference can be displayed.

When activating a hyperlink in a compound document (e.g., a document containing sub-documents), there are several possible behaviors. If the link is in the top-level document then the whole document can be replaced by the referenced document. If the link is in a sub-document it may be desirable to replace only the sub-document with the referenced document. This is typically the default behavior of the system, but the designer can specify any sub-document element as a “launcher” element, which can cause an activated link in that element to replace the top-level document or another indicated sub-document instead. This feature can be useful for a sub-document that implements an index or a table of contents. An author makes an element a launcher by setting the “launcher” attribute to true in any element or location node. Launcher elements can facilitate linked documents to replace the top level document unless the “target” attribute is also set on the element. The “target” attribute can be set to the name of another element in the template, and the linked document can then replace the sub-document currently displayed in the named element.

Another way of activating links is to drag and drop the links into sub-document elements on the page. On a page containing a collection of multiple sub-documents, like, for example, a newspaper, a user can thereby pull a story out of an index and drop it into one of the story locations on the page.

Results

A number of document/applications have been described that demonstrate the range and power of the subject innovation. The applications include an adaptive version of the online magazine Slate, a news-reader that takes stories from the New York Times RSS feed, scrapes the full content from their website, and displays the stories in the format of a broadsheet newspaper, and a front-end for the internet news-aggregator MSN NewsBot that makes database requests over the internet to retrieve current breaking news updates from thousands of web sources, and can operate as an adaptive front page gateway to aggregate individual adaptive sub-documents. Other implementations can include, for example, an MSN Search front-end that presents search results in a high-quality adaptive display.

The Slate magazine implementation demonstration was built using the AGBDL template system. It required 74 templates to implement pages covering 1 to 3 columns layouts. The New York Times demo uses the new template system and implements layouts of 1 to 6 columns but requires only 5 templates. Each of the five templates is about a quarter the size of the templates produced for the Slate demo.

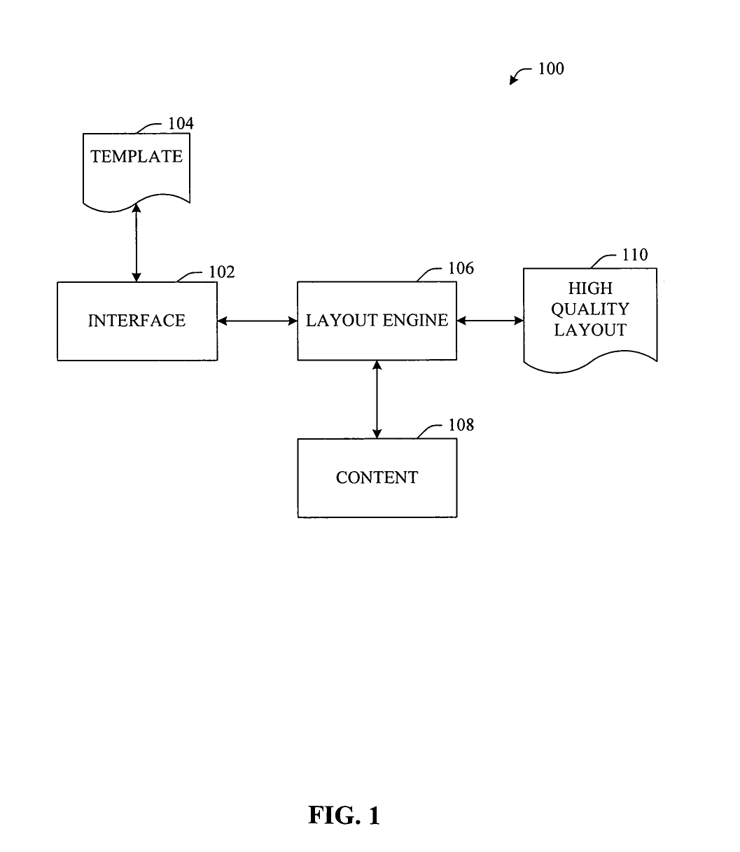

Referring now to FIG. 1, a system 100 that facilitates adapting a document layout that can be displayed at multiple sizes and dimensions with a wide variety of content is depicted. Generally, the system 100 can include an interface 102 that receives a template 104. The template 104 can be a high level description of constraints for a document layout. The layout engine 106 can interpret the template 104 and, based upon the high level constraints of the template 104, determine where to place content 108 within a document in order to produce a high quality document 110.

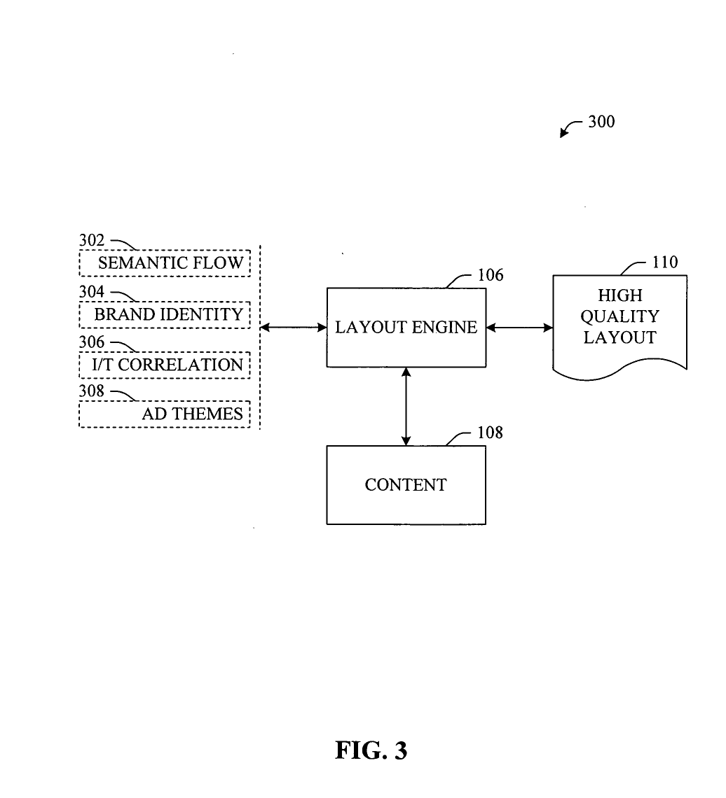

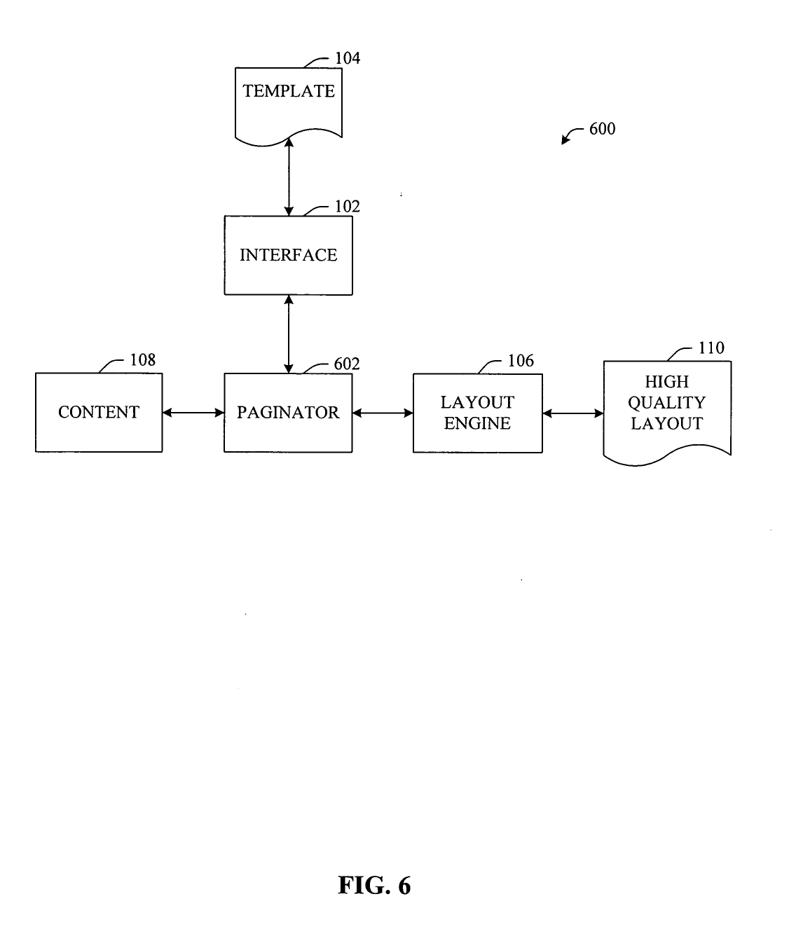

As detailed above, a high quality document is a document in which the displayed output is determined to look good given the present display dimensions and the content. The determination of whether the displayed output looks good can be based upon the overall visual effects as well as other attributes discussed in more detail with reference to FIGS. 3 and 6, infra. Accordingly, the layout engine 106 typically requires prior knowledge of the type(s) of content to be arranged and the display dimensions of the arrangement prior to creating the high quality layout 110. However, it is to be appreciated that the template 104 need not have prior knowledge and typically does not have prior knowledge of either the type(s) of content or the display dimensions when the template 104 is created or when the template 104 is received by the layout engine 106.

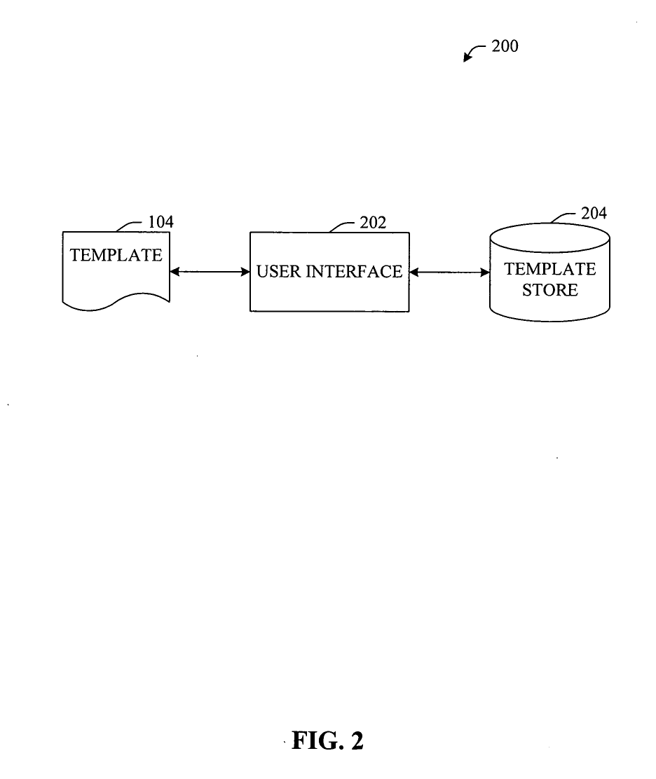

Turning now to FIG. 2, a system 200 generally comprising a user interface 202, a template 104 and a template store 204 is illustrated. The user interface 202 can facilitate creation, design and/or modification of templates, such as template 104. Similarly, the template store 204 can store templates such as template 104. It is to be appreciated that the user interface 202 can be either text based or a graphical user interface (GUI) that can be employed to construct the template 104 via high level constraint parameters and provide storage for the template 104 via, e.g., the template store 204. It should also be appreciated that although only a single template 104 is depicted in FIG. 2, the interface 102 can be employed to create, design and/or modify any number of templates 104. Similarly, the template store 204 can store a plurality of templates 104 that can be retrieved by the user interface 202 to be modified and/or supplied e.g., to the layout engine 106 (FIG. 1) or the paginator 602 (FIG. 6).

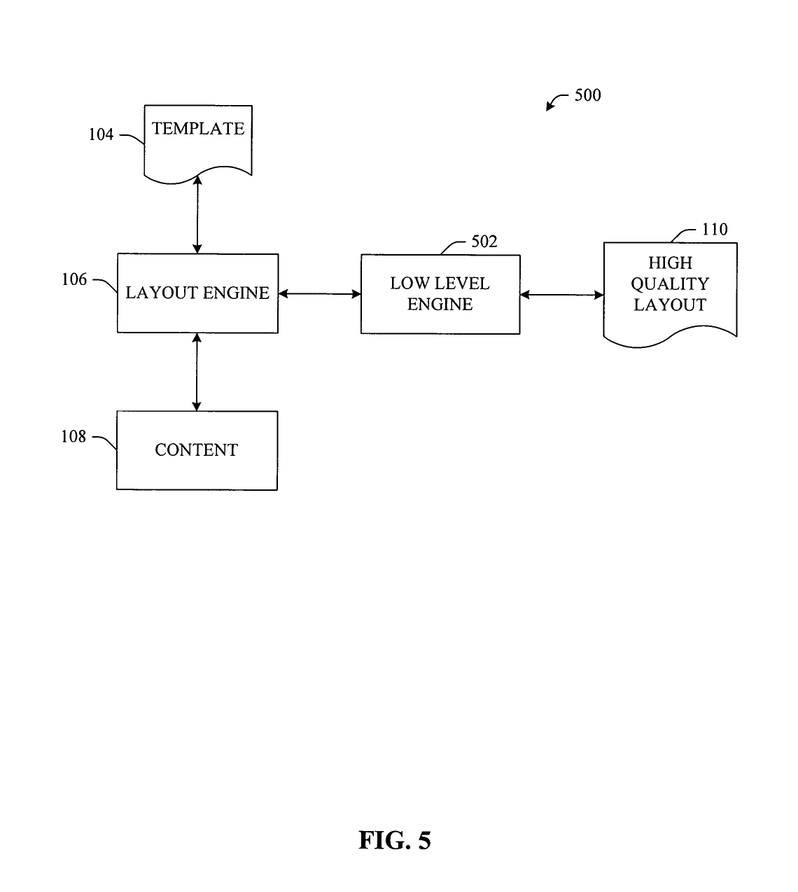

The template 104 can consist of a number of parameters, such as a definition of the screen elements for a layout (e.g., high level constructs that describe the elements as well as supplying what type(s) of content those elements can be used for), and a constraint system that can control how the elements are arranged with respect to one another (e.g., the over and under commands described supra). Accordingly, the template 104 provides a high level language that can be employed to specify many different aspects of a layout. As well, this high level language can be a more natural description language, easier to author while at the same time capable of expressing broader concepts with fewer statements. In addition, this high level language can be translated into a low level description as described in more detail with respect to FIG. 5 below.

Referring now to FIG. 3, a system 300 that generally includes the layout engine 106 capable of producing the high quality layout 110 is depicted. As described above, the layout engine 106 can receive a template (not shown) that provides high level constraints to beadheard to in the creation of the high quality layout 110. However, the layout engine 106 must actually arrange the content 108 such that the arrangement adheres to the overriding constraints of the template as well as the conditions necessary so that the output is a high quality layout 110.

Typically, the layout engine 106 will examine the type and/or types of content 108 as well as the display dimensions for the high quality layout 110 before determining how to arrange the content 108. In some cases (e.g., depending on the type(s) of content or other factors), the layout engine 106 can employ other considerations such as semantic flow 302, brand identity 304, item and text correlation 306 and advertising themes 308. In some instances, a layout will not be a high quality layout 110 unless at least one of semantic flow 302, brand identity 304, item and text correlation 306 and advertising themes 308 are considered.

Semantic flow 302 can generally refer to the actual meanings of words and, hence, typically relies on the meaning of words relative to other words. Accordingly, some content 108 elements or types, such as newspaper headlines have a strong semantic rationale for keeping words together to prevent ambiguity, even though splitting them up to arrange the words in different locations may provide for a simpler solution for the layout arrangement. For example, there can be an effective semantic flow 302 rationale to avoid placing a line break right after a negating prefix or word.

The layout engine 106 can also consider brand identity 304 when generating a high quality layout 110. For example, the content 108 could be a trademark that consists of two related images that overlap in a well recognized pattern or the brand requires other content 108 (e.g., the well known Intel trademark that includes a graphic swirl, the text “Intel Inside” and four audio tones) to be fully illustrative. If each images and/or other content are not arranged properly, then the layout can lose some of the effects and/or meaning that other design media with design editors can otherwise achieve.

In addition, the layout engine 106 can also consider item and text correlation when creating a high quality layout 110. For example, newspapers will generally provide a small caption describing items. As well, images (e.g., items) could have callouts to indicate features of the picture or text spoken by the characters in the photograph. In those cases, it is important to consider the location of certain text in relation to an item.

Similarly, the layout engine 106 can consider advertising themes 308 in producing high quality layouts 110. Advertising themes 308 can rely on any of the several examples given above regarding items 302-306, and for similar reasons can require additional analysis by the layout engine 106. However, it is to be appreciated that advertising themes 308 can require conditions that might otherwise contradict other consideration

understood that the above examples are merely illustrative and in no way intended to be limiting. Other applications could be employed without departing from the scope and spirit of this invention.

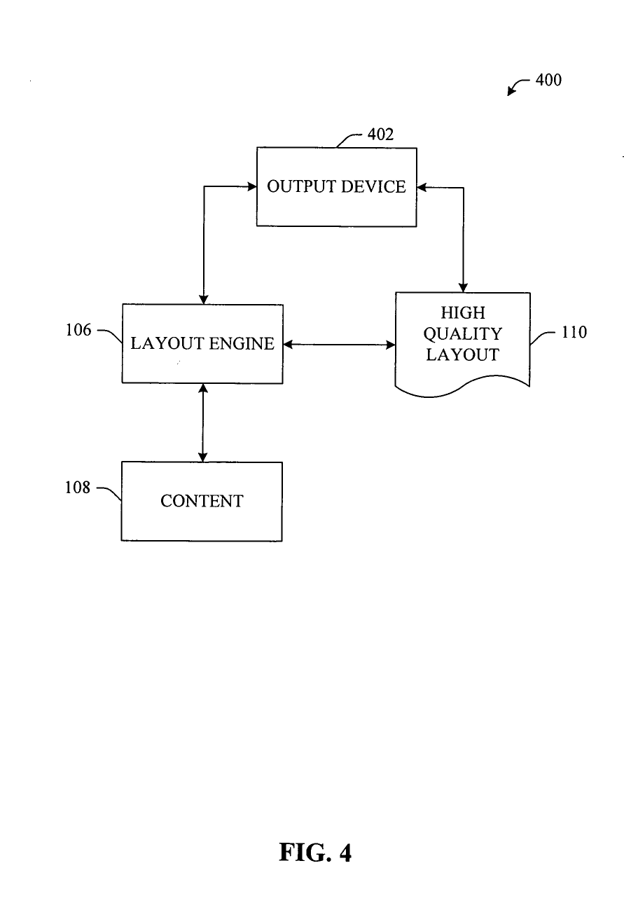

Referring briefly to FIG. 4, a system 400 that facilitates adapting a document layout that can be displayed at multiple sizes and dimensions with a wide variety of content is shown. The system 400 generally includes a layout engine 106, content 108, a high quality layout 110 and an output device 402. The output device 402 can be virtually any device capable of displaying digital content from tiny wrist displays, portable hand-held devices, digital fabrics, work stations, wall mounted displays and even very large displays for roadside billboards and buildings. Typically, the layout engine 106 will determine the size and dimension of the high quality layout 110 based upon the output device 402.

Turning now to FIG. 5, a system 500 that generally comprises the template 104, the layout engine 106, the content 108, the high quality layout 110and a low level engine 502 is depicted. The low level engine 502 can apply the content 108 to an adaptive grid-based layout based upon low level constraints. However, the low level engine 502 does not have the capability to accept a high level template 104, but, if provided enough detail and abstraction (e.g., by the layout engine 106), the low level engine can produce a high quality layout 110. The low level engine 502is described in detail below in the AGBDL system. As described supra, the layout engine 106 can determine how to arrange content 108 based upon the high level constraints provided in the template 104 (as well as based upon additional conditions, if any) in order to produce a high quality layout 110. Once the exact layout is known that will produce a high quality layout 110, the layout engine 106 can also translate this information into low level constraints such that the low level engine 502 can produce the high quality layout 110.

FIG. 6 illustrates a system 600 that facilitates adapting a document layout that can be displayed at multiple sizes and dimensions with a wide variety of content. The system 600 generally includes the interface 102, the template 104, the layout engine 106, content 108, the high quality layout 110, and a paginator 602. The paginator 602 is described in detail infra in the AGBDL section; however, in this context the paginator 602 provides a level of abstraction for the layout engine 106. For example, the paginator 602 receives the content 108 and also communicates with the interface 102 in order to select the template 104 that will be used for the given content 108. It is to be appreciated that the paginator 602 could alternatively retrieve the template 104 directly from e.g., the template store 202 of FIG. 2. The layout engine 106 receives the template 104 and the content 108 and arranges the content 108 in order to produce a high quality layout 110. In essence, the paginator 602 can determine which template 104 to use for each document and/or each page of the document and the layout engine 106can determine how to arrange the actual content 108in a manner that is consistent with a high quality layout 110.

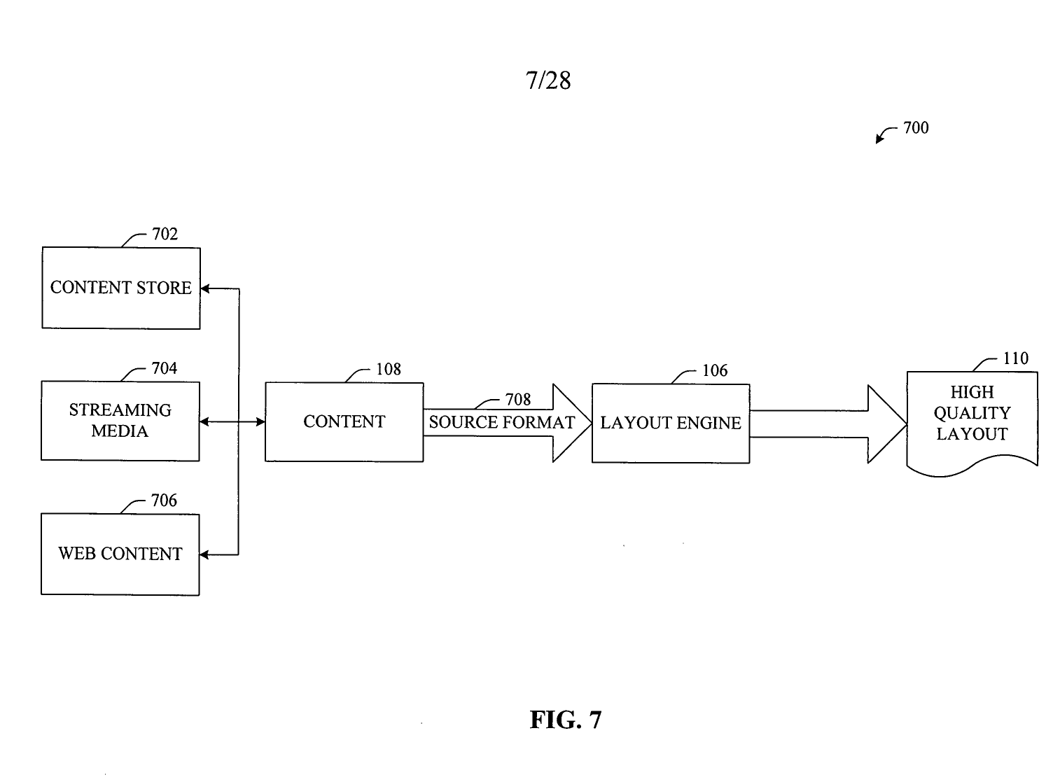

Turning now to FIG. 7, a system 700 for producing a high quality layout 110 is illustrated. Generally, the system 700 includes a layout engine 106 that receives content 108. According to an exemplary embodiment, the content 108 can be of disparate type(s), aggregated from multiple sources. For example, content 108 can be retrieved from a content store 702 such as a data store; streaming media 704 such as from a hardware device; and web content 706, which can be a wide variety of content types. Accordingly, since the content 108 can be supplied from various sources, the source format 708 of the content 108 will conceivably vary considerably. Therefore, the layout engine 106 can receive the content 108 formatted in the source format 708 and can translate the source format into a format the layout engine 106 can employ to produce a high quality layout 110. The source format 708 by, e.g., XLST, and the translation can be performed automatically as described supra.

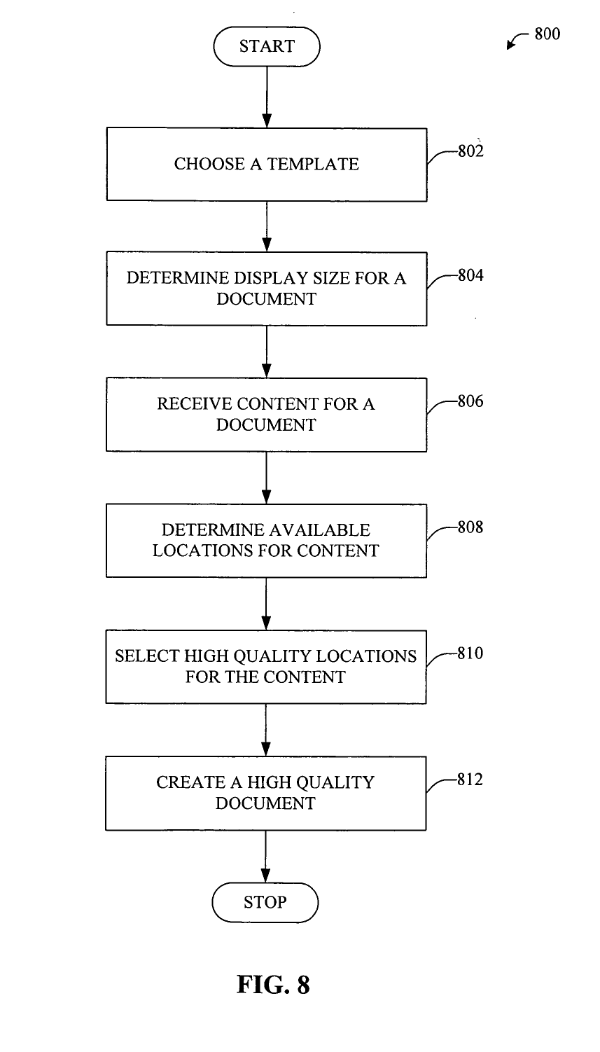

FIG. 8 illustrates methodology 800 in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 8, an exemplary computer implemented methodology 800 for arranging content to create a high quality layout is illustrated. At 802, a template for a document layout can be chosen. Typically, the template is defined in a high level language and can be selected from a template store by one of an interface, a paginator and a layout engine. At 804, a display size for the document can be determined. It is to be appreciated that this determination can be made based upon the screen size of an output device and/or a region within. At 806, content for the document can be received. As previously described, the content can come from a wide range of sources such as a content store, streaming media, the Internet, etc., and can exist in a wide variety of formats that may be inconsistent with the format of a high quality layout and, thus, require appropriate translation.

At 808, the available locations for the specific content can be determined by employing the high level constraints supplied, e.g., by a template, as well as the display size for the ultimate high quality layout. It is to be appreciated that many available locations for specific content can exist. At 810, a high quality location can be selected from the available locations determin set forth above, a high quality location is one in which the location for which specific content can be introduced while maintaining the high quality character of the overall layout. It is to be understood that selecting a high quality location can rely upon numerous criteria. For example, the high quality locations can be determined based upon at least one of a series of algorithms such as best fit, first fit, first good fit, and the like. Such a determination can also rely on other conditions such as semantic flow, brand identity, item and text correlation, advertising themes, as well as others. At step 812, a high quality layout can be created.

AGBDL System

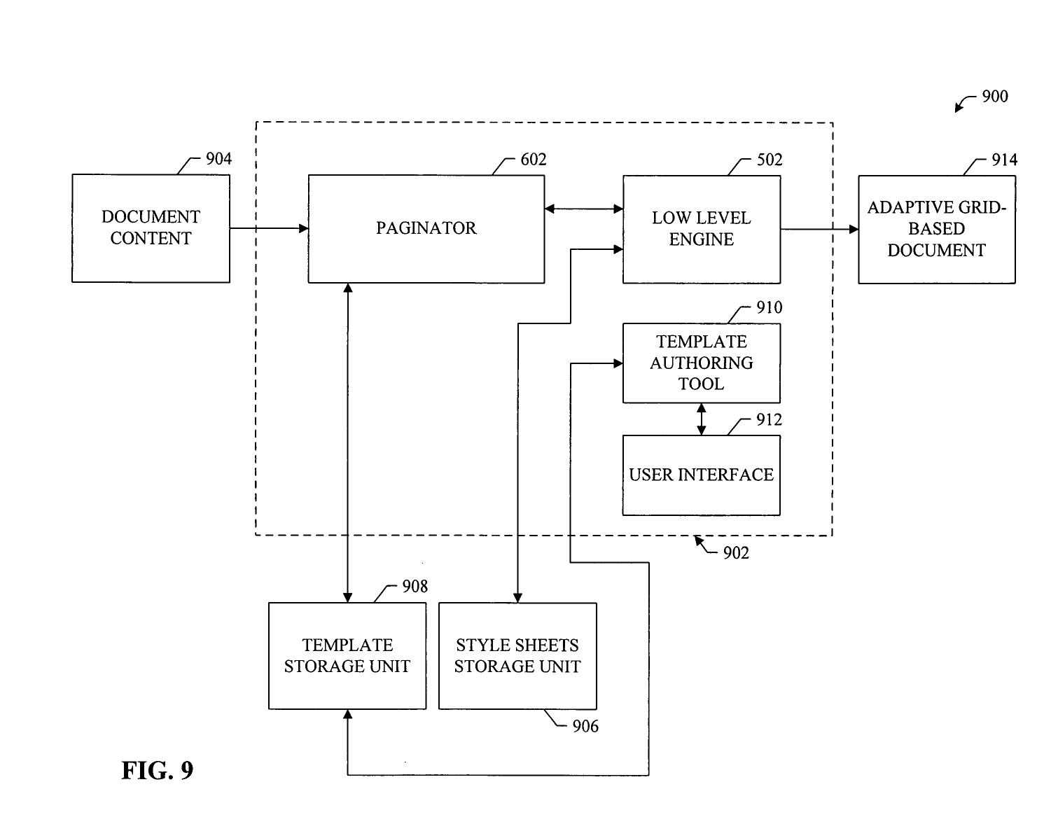

FIG. 9 displays a block diagram representation of an adaptive grid-based document layout environment 900 in accordance with an exemplary embodiment of the claimed subject matter. The adaptive grid-based document layout environment 900 comprises an adaptive grid-based document system 902, style sheet storage unit 906, and template storage unit 908. The adaptive grid-based document layout environment 900 is supported by hardware and software components similar to those found in well-known computing systems, environments, and/or configurations described more fully below with reference to FIG. 10. The adaptive grid-based document system 902 comprises a paginator 602, low level engine 502, template authoring tool 910, and user interface 912.

The style sheet storage unit 906 communicatively connects to the adaptive grid-based document system 902 via the low level engine 502. The style sheet storage unit 906 stores style sheet data used to specify the styling of text within document content 904. The style sheets storage unit 906 comprises a memory device capable of storing and retrieving data including, but not limited to, random access memory (RAM), flash memory, magnetic memory devices, optical memory devices, hard disk drives, removable volatile or non-volatile memory devices, optical storage mediums, magnetic storage mediums, or RAM memory cards. Alternatively, the style sheets storage unit 906 may comprise a remote storage facility accessible through a wired and/or wireless network system. Additionally, the style sheets storage unit 906 may comprise a memory system including a multi-stage system of primary and secondary memory devices, as described above. The primary memory device and secondary memory device may operate as a cache for each other or the second memory device may serve as a backup to the primary memory device. In yet another arrangement, the style sheets storage unit 906 may comprise a memory device configured as a simple database file or as a searchable, relational database using a query language, such as SQL.

The template storage unit 908 communicatively connects to the adaptive grid-based document system 902 via the paginator 602 and the template authoring tool 910. The template storage unit 908 stores a plurality of templates 1106, wherein each template 1106 may be used to define the layout of a single page of document content 904. The layout of the document content may include pages laid out according to one or more templates 1106. The template storage unit 908 comprises a memory device similar to the memory devices described above with reference to the style sheet storage unit 906.

The paginator 602 communicatively connects to the low level engine 502 and template storage unit 908. The paginator 602 is configured with hardware and software (see FIG. 10) appropriate to perform tasks and provide capabilities and functionality as described herein. Additionally, the paginator 602 may receive document content 904 for processing into an adaptive grid-based layout. The document content 904 may be represented by a variety of content streams 1303 that identify various content types such as, but not limited to, body text, images, inline figures, sidebars, captions, media, and other appropriate document content 904. Generally, the paginator 602 determines a mapping of document content 904 onto individual templates 1106, which may include, but is not limited to, the globally optimal pairing of document content 904with templates 1106.

The low level engine 502 communicatively connects to the paginator 602 and style sheets storage unit 906. The low level engine 502 is configured with hardware and software (see FIG. 10) appropriate to perform tasks and provide capabilities and functionality as described herein. The low level engine 502 may receive document content 904 and templates 1106 from the paginator 602 for processing. Typically, the low level engine 502 formats document content 904 automatically by use of templates 1106 (e.g., applies templates 1106 to the document content 904) and thereby creates adaptive grid-based documents 914. Additionally, the low level engine 502 may be used to determine a quality score for each part (e.g., each page) of the adaptive grid-based document 914 created from the application of templates 1106 to the document content 904.

In operation, the adaptive grid-based document system 902 via the paginator 602 receives document content 904 to be processed and templates 1106 from the template storage unit 908. The paginator 602 provides the document content 904 and templates 1106 to the low level engine 502 for rendering of actual page layouts. In an alternative embodiment of the claimed subject matter, the low level engine 502 is communicatively connected to the template storage unit 908 and, therefore, the low level engine 502 receives templates 1106 directly from the template storage unit 908. The low level engine 502 applies style sheets from the style sheets storage unit 906 and templates 1106 to the document content 904 and determines a quality score based on the results. The low level engine 502 provides the paginator 602 with all valid template 1106 sequences (e.g., all template 1106 sequences that successfully and completely adapt the document content 904 to a grid-based document layout) and their corresponding quality scores. The paginator 602 computes either some desirable sequence of templates 1106 or the globally optimal sequence of templates 1106 based on the quality scores provided by the low level engine 502. After determining a pairing of content with a sequence of templates 1106, the paginator 602 provides the document content 109 and the optimal sequence of templates 1106 to the low level engine 502. The low level engine 502 automatically formats the document content 904 according to the optimal sequence of templates 1106. The resulting adaptive grid-based document 914 is then provided by the adaptive grid-based document system 902 to the appropriate destination (e.g., displayed to the user, provided to another program module, or saved to a file).

The template authoring tool 910 communicatively connects to the template storage unit 908and a user interface 912. The template authoring tool 910 is configured with hardware and software (see FIG. 10) appropriate to perform tasks and provide capabilities and functionality as described herein. The user interface 912 provides a user with a set of windows, icons, commands, and/or menus for creating or modifying templates 1106 within the template storage unit 908. Through use of the template authoring tool 910 and the user interface 912, a user may draw and arrange layout elements, specify how the elements adapt to different page sizes, preview the adaptation interactively, and set template 1106 preconditions 1109 and constraint-based relationships 1115.

In operation, the user interface 912 presents a schematic representation of a template 1106 that may be interactively resized. Creating a new layout element 1112 within the template 1106, generally, requires the user to draw a region on the user interface 912 display and then manipulate the region to a desired size, position, and layer. To maintain the integrity of the adaptive templates 1106, most elements 1112 of the template 1106 require constraint-based relationships 1115.

While creating or editing a template, the user may specify page-level constraints by defining a page grid by drawing horizontal or vertical guides and then using a snap-dragging interface to constrain the elements relative to the grid. The horizontal or vertical guides may be designed to either scale relative to the page or maintain a constant offset. Guides may also be dependent on other guides, allowing a user to define a hierarchical grid. Specifically, the user interface 912 supports different types of user operations including, but not limited to: (1) if the user adds a new guide without first selecting any other guides, then the new guide's position is defined relative to the entire page; (2) if the user selects a single existing guide before creating a new guide, then the new guide's position is defined as a constant offset from the selected guide; and (3) if the user selects two existing guides before creating a new guide, then the new guide's position is defined relative to the two selected guides. The user interface 912 may also provide user operations that allow the user to specify constraints directly between elements without the use of guides. For example and not limitation, the user may constrain the bottom of one element to coincide with the top of another element. To address situations where an element's size is determined by the content flowed into that element (and not the geometry of the page alone), the user may utilize the template authoring tool 910 to constrain one of the element's dimensions and then specify that the other dimension be determined from document content 904.

After creating a custom template 1106, the user may specify additional preconditions based on the value of any variable in a constraint system. The suitability of a template 1106 for document content 904 depends on the use of preconditions and a scoring function. Once a user sets the content sources of an element 1112 of the template 1106, the content preconditions for a template 1106 may be automatically computed. Additionally, a user may add attribute preferences to elements 1112 that influence the quality score that the page template 1106 receives for a given selection of document content 904. When the user specifies more than one attribute of an element 1112, the user may rank the attributes in order of importance via the user interface 912.

The template authoring tool 910 may then automatically construct a scoring function that the low level engine 502 evaluates for different selections of document content 904 that may possibly be flowed into the element. Given the user-specified ranking of attributes in order of importance, the template authoring tool 910 may associate each attribute with a digit in the score, with higher order digits corresponding to more important attributes. When the low level engine 502 evaluates a selection of content, the score may be computed by associating a “1” with all matching attributes, and a “0” with all non-matching attributes. More specifically, if “al” through “aN” are the N user-specified attribute preferences in order of importance, then the scoring function is constructed by the authoring system as follows: S=match(a1, b1)*(10ˆ(N−1)) + match(a2, b2 )*(10ˆ(N−2)) . . . +match(aN, bN)*(10ˆ0), where S is the quality score of a particular selection of content being evaluated, b1 through bN are the actual attribute values associated with the selection of content, and match(a, b) is a function that returns “1” when “a” equals “b” and “0” otherwise. Thus, this scoring function returns a better or worse score, depending on how well the content matches the attributes specified by the user. The scoring function ensures that more important attributes are given strict priority over less important attributes. For example and not limitation, a selection of content that matches a particular attribute “A” results in a better score than other selections of content that do not match attribute “A” but potentially do match less important attributes.

One skilled in the art will recognize that scoring functions may be implemented in a variety of ways. For example and not limitation, each attribute of an element may be associated with a digit in the final score. The importance of the attribute determines its corresponding digit, with the most important attribute being associated with the most significant digit. Consequently, an attribute that is the k-th most important attribute will correspond with the k-th most significant digit in the final score. For a particular selection of content, the scoring fimction may associate a “1” with the digits that correspond to matching attributes and a “0” with the digits that correspond to non-matching attributes. The scoring function, therefore, ensures that a piece of content that matches the most important attribute has a higher (i.e., better) score than any other selection of content that does not match the most important attribute.

Different templates 1106 within a layout style 1103 often include common characteristics (e.g., elements, preconditions, and constraints). Accordingly, the template authoring tool 910 may support a system or model of template 1106 inheritance that simplifies the modification of common characteristics across several templates 1106 without actually changing each of the templates 1106 individually. For example and not limitation, a user may create a new template 1106 (e.g., a child template 1106) that inherits characteristics of a pre-existing template 1106 (e.g., a parent template 1106). The child template 1106 automatically includes all of the elements, preconditions, and constraints of the parent template 1106. Next, the user may add additional elements, preconditions, and constraints to the child template 1106 in order to create the desired custom template 1106. If the user wants to change one of the properties that is common between the parent and child templates 1106, then the user need only modify the properties of the parent template 1106, because the modification will propagate via inheritance to all child templates 1106 of the parent template 1106. The inheritance model simplifies the management of a large number of templates 1106 and helps to maintain consistency between the templates 1106.

One skilled in the art will recognize that connecting communicatively may include any appropriate type of connection including, but not limited to, analog, digital, wireless and wired communication channels. Such communication channels include, but are not limited to, copper wire, optical fiber, radio frequency, infrared, satellite, or other media.

FIG. 10 displays a block diagram representation of a computing environment 1000 and computer systems 1010, 1080 thereof which the claimed subject matter can utilize in accordance with an exemplary embodiment thereof. The computing environment 1000 and computer systems 1010, 1080 thereof represent only one example of a suitable computing environment and computer systems for the practice of the claimed subject matter and are not intended to suggest any limitation as to the scope of use or functionality of the invention. Nor should the computer systems 1010, 1080 be interpreted as having any dependency or requirement relating to any one or combination of components illustrated in the exemplary computing environment 1000.

Hence, it should be understood that the subject invention is operational with numerous other general purpose or special purpose computing system environments or configurations. Examples of well-known computing systems, environments, and/or configurations that may be appropriate or suitable for use with the claimed subject matter include, but are not limited to, personal computers, server computers, hand-held or laptop devices, multiprocessor systems, microprocessor-based systems, set top boxes, programmable consumer electronics, network personal computers, minicomputers, mainframe computers, distributed computing environments that include any of the above systems or devices, and the like.

Aspects of the claimed subject matter may also be described in the general context of comprising computer-executable instructions, such as program modules, being executed by a computer system. Generally, program modules include routines, programs, programming, objects, components, data, data structures, etc. that perform particular tasks or implement particular abstract data types. Features of the subject invention may be practiced in distributed computing environments where tasks are performed by remote processing devices that are linked through a communications network. In a distributed computing environment, program modules may be located in both local and remote computer storage media, including, without limitation, in memory storage devices.

With reference to FIG. 10, an exemplary computing environment 1000 of the claimed subject matter includes a general purpose computing device in the form of a computer system 1010. Components of computer system 1010 may include, but are not limited to, a processing unit 1020, a system memory 1030, and a system bus 1021 that couples various system components including the system memory 1030 to the processing unit 1020 for bidirectional data and/or instruction communication. The system bus 1021 may be any of several types of bus structures including a memory bus or memory controller, a peripheral bus, and a local bus using any of a variety of bus architectures. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (i.e., also known as the “Mezzanine bus”).

Computer system 1010 typically includes a variety of computer-readable media. Computer-readable media may comprise any available media that may be accessed by, read from, or written to by computer system 1010 and may include both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data, data structures, program modules, programs, programming, or routines. Computer storage media includes, but is not limited to, RAM, ROM, EEPROM, flash memory or other memory technology, CD-ROM, digital versatile disks (DVD) or other optical disk storage, magnetic cassettes, magnetic tape, magneto-optical storage devices, magnetic disk storage or other magnetic storage devices, or any other medium which may be used to store the desired information and which may be accessed by computer system 1010. Communication media typically embodies computer-readable instructions, data, data structures, program modules, programs, programming, or routines in a modulated data signal such as a carrier wave or other transport mechanism and includes any information delivery media. The term “modulated data signal” means a signal that has one or more of its characteristics set or charged in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer-readable media.

The system memory 1030 includes computer storage media in the form of volatile and/or nonvolatile memory such as read only memory (ROM) 1031 and random access memory (RAM) 1032. A basic input/output system 1033 (BIOS), containing the basic routines that direct the transfer of information between elements within computer 1010, such as during start-up, is typically stored in ROM 1031. RAM 1032 typically stores data and/or program instructions that are immediately accessible to and/or presently being processing unpon way of example, and not limitation, FIG. 10 illustrates operating system 1034, application programs 1035, other program modules 1036, and program data 1037 which may be resident in RAM 1032, in whole or in part, from time-to-time.

The computer 1010 may also include other removable/non-removable, volatile/nonvolatile computer storage media. By way of example only, FIG. 10 illustrates a hard disk drive 1041 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as a CD ROM or other optical media. Other removable/non-removable, volatile/nonvolatile computer storage media that may be included in the exemplary computing environment 1000 include, but are not limited to, magnetic tape cassettes, flash memory cards, digital versatile disks, digital video tape, solid state RAM, solid state ROM, and the like. The hard disk drive 1041 is typically connected to the system bus 1021 through a non-removable memory interface such as interface 1040, and magnetic disk drive 1051 and optical disk drive 1055 are typically connected to the system bus 1021 by a removable memory interface, such as interface 1050.

The drives 1041, 1051, 1055 and their associated computer storage media described above and illustrated in FIG. 10, provide storage of computer-readable instructions, data, data structures, program modules, programs, programming, or routines for computer system FIG. 10, for example, hard disk drive 1041 is illustrated as storing operating system 1044, application programs 1045, other program modules 1046, and program data 1047. Note that these components may either different from operating system 1034, application programs 1035, other program modules 1036, and program data 1037. Operating system 1044, application programs 1045, other program modules 1046, and program data 1047 are given different numbers to illustrate that, at a minimum, they are different copies of operating system 1034, application programs 1035, other program modules 1036, and program data 1037. A user may enter commands and information into computer system 1010 through connected input devices such as a keyboard 1062 and pointing device 1061, common a mouse, trackball or touch pad. Other connected input devices (not shown) may include a microphone, joystick, game pad, satellite dish, scanner, or the like. These and other input devices are often connected to the processing unit 1020 through a user input interface 1060 that is coupled to the system bus 1021, but may be connected by other interface and bus structures, such as a parallel port, game port or a universal serial bus (USB). A monitor 1091 or other type of display device is also connected to the system bus 1021 via an interface, such as a video interface 1090. In addition to the monitor 1091, computer system 1010 may also include other peripheral output devices such as speakers 1097 and printer 1096, which may be connected through an output peripheral interface 1095.

The computer system 1010 may operate in a networked environment using bidirectional communication connection links to one or more remote computer systems, such as a remote computer system 1080. The remote computer system 1080 may be a personal computer, a laptop computer, a server computer, a router, a network PC, a peer device or other common network node, and typically includes many or all of the elements described above relative to the computer system 1010, although only a memory storage device 1081 of remote computer system 1080 has been illustrated in FIG. 10. The bi-directional communication connection links depicted in FIG. 10 include a local area network (LAN) 1071 and a wide area network (WAN) 1073, but may also include other networks. Such networks are commonplace in offices, enterprise-wide computer networks, intranets and the Internet.

When communicatively connected to a LAN 1071, the computer system 1010 connects to the LAN 1071 through a network interface or adapter 1070. When communicatively connected to a WAN 1073, the computer system 1010 typically includes a modem 1072 or other means for establishing a communication link over the WAN 1073, such as the Internet. The modem 1072, which may be internal or external, may be connected to the system bus 1021 via the user input interface 1060, or other appropriate mechanism. In a networked environment, program modules depicted relative to the computer system 1010, or portions thereof, may be stored in the remote memory storage device 1081. By way of example, and not limitation, FIG. 10 illustrates remote application programs 1085 as residing in memory storage device will be appreciated that the network connections shown are exemplary and other means of establishing a bi-directional communication link between the computers may be used.

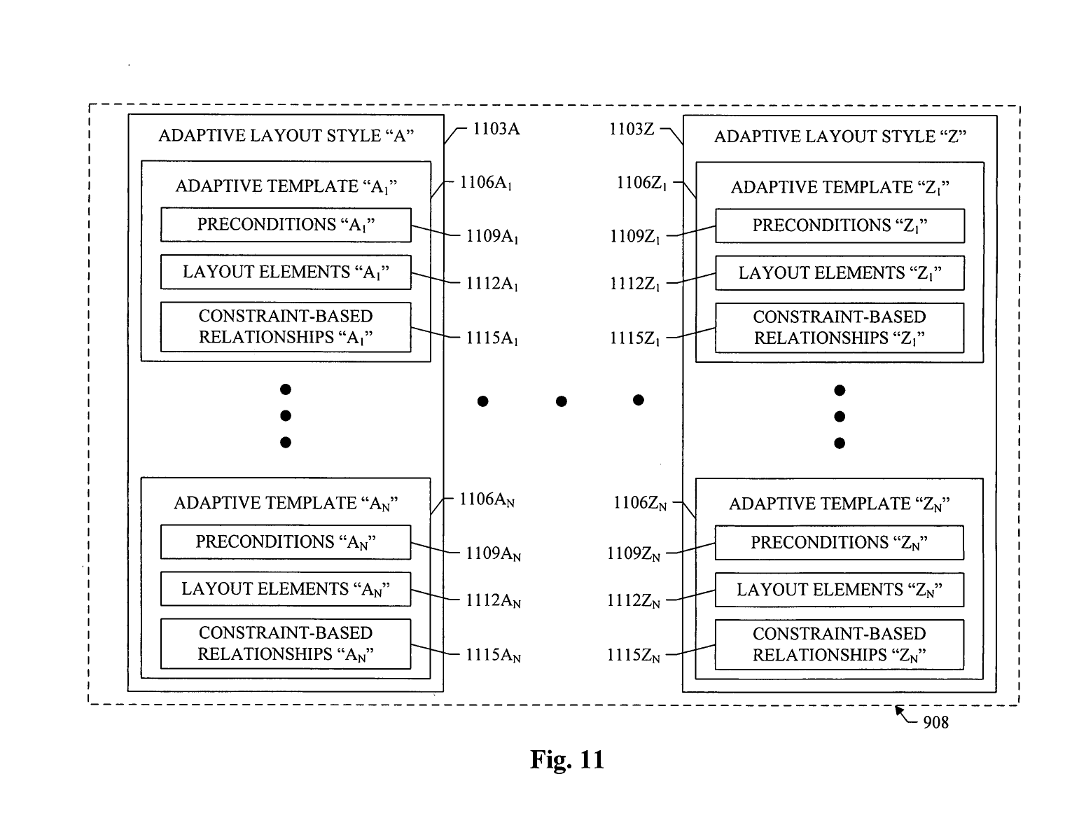

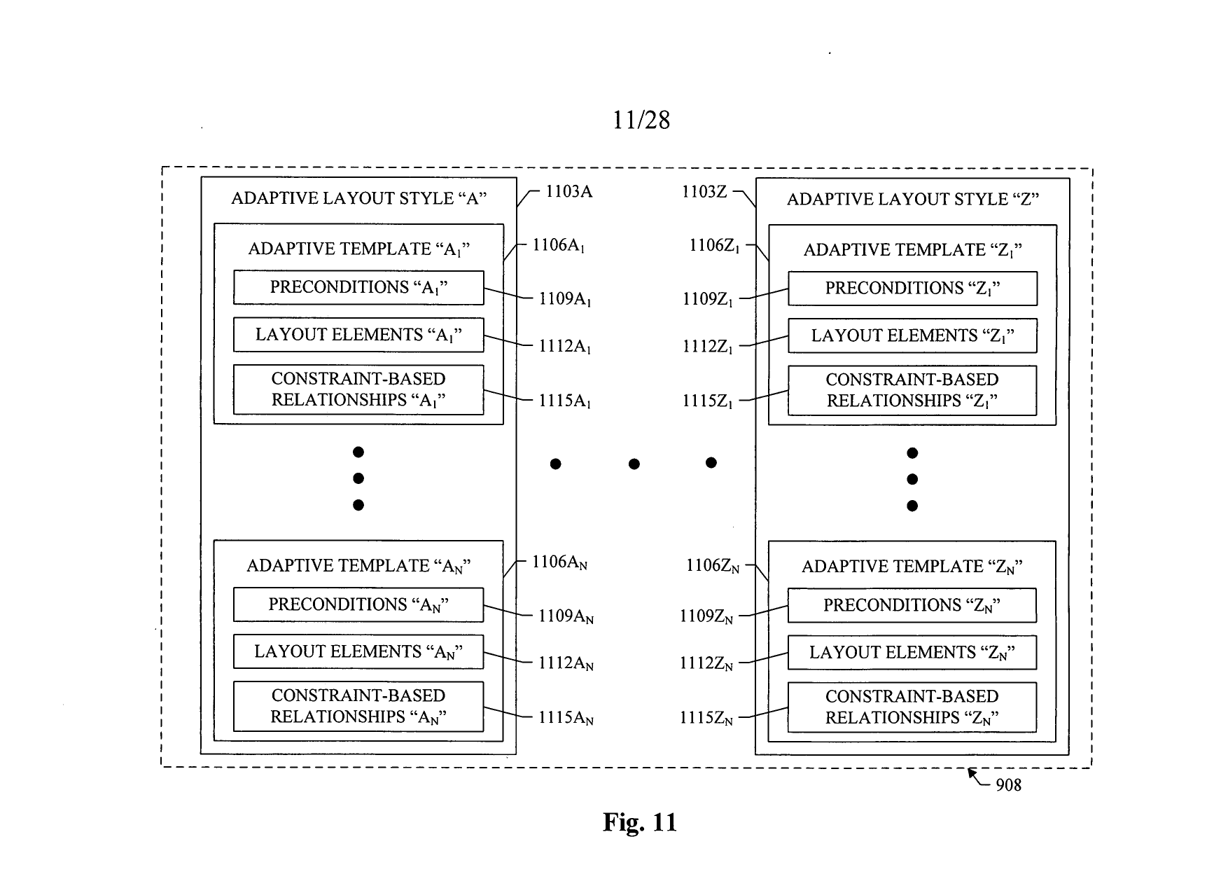

FIG. 11 displays a block diagram representation of a document layout including adaptive layout styles 1103 and templates 1106 in accordance with an exemplary embodiment of the claimed subject matter. Document content 904 is formatted into a particular document layout by use of templates 1106 (e.g., sometimes referred to herein as “adaptive templates 1106”) stored in the template storage unit 908. Each template 1106 is responsible for defining the layout for a single page of content across a range of page dimensions. In the exemplary embodiment of the claimed subject matter, the template 1106supports a protocol whereby alternative document content (e.g., a wider version of an optimal drawing) may be automatically chosen if it improves the overall page layout of the document. Also, each template 1106 is designed to adapt to a range of display dimensions, as well as to other types of viewing conditions, such as an increase in font size.

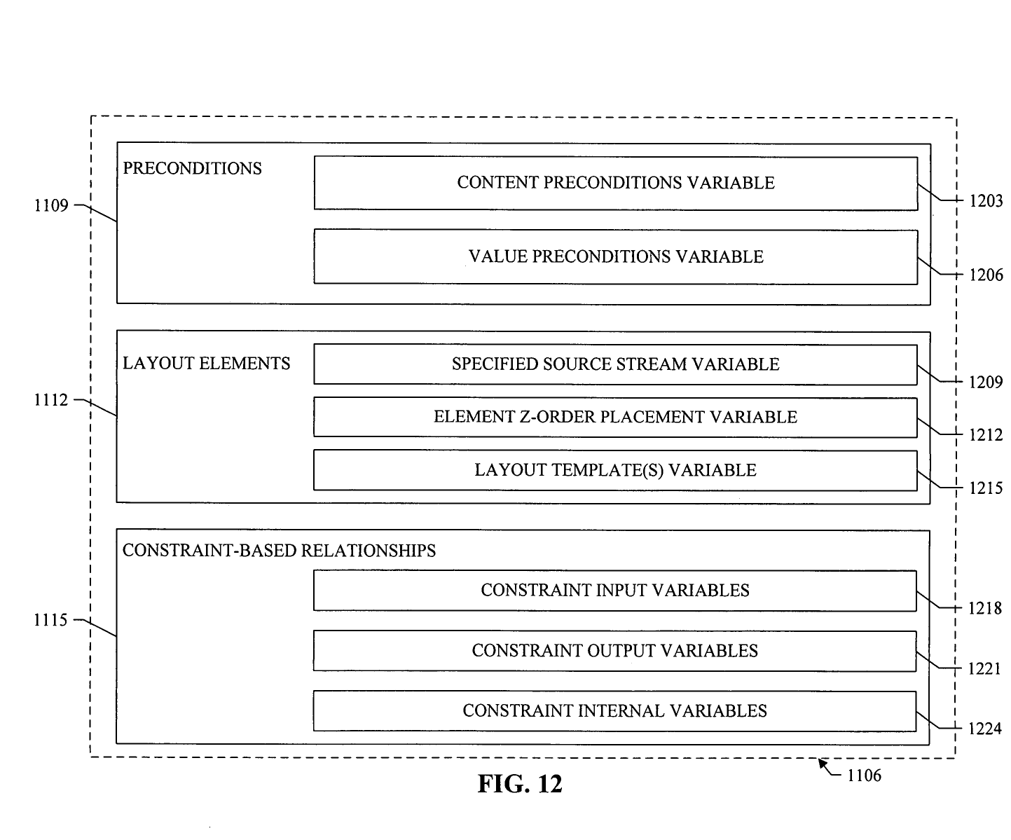

Each template 1106, additionally, may comprise layout elements 1112, constraint-based relationships 1115, and preconditions 1109. A layout element 1112 represents a particular region within the page of the template 1106 in which content may be placed. A constraint-based relationship 1115 of the template 1106 helps to define the relationships between elements 1112. A precondition 1109 of the template 1106 characterizes the suitability of the template 1106 for the particular content of a document or the characteristics of a page. The layout elements 1112, constraint-based relationships 1115, and preconditions 1109 are more fully described below with reference to FIG. 12.

In one embodiment of the claimed subject matter, document layout is described using a set of templates 1106. When the document content 904 is applied to the templates 1106, adaptive grid-based document 914 is produced in an optimal format. For example, the present system may support a wide-range of modern, grid-based layout styles such as designs used for the New York Times, the New Yorker, the Washington Post, Newsweek, or Time magazine. Each of the layout styles 1103 (e.g., sometimes referred to herein as an “adaptive layout style 1103”) is defined by a collection of templates 1106 that implement the particular characteristics of the particular layout style 1103.

As illustrated in FIG. 11, an adaptive layout style 1103A is represented by a set of templates 1106A₁, 1106A_{N}. The ellipsis between adaptive template “A₁” 1106A₁and adaptive template “A_{N}” 1106A_{N} illustrates that a plurality of adaptive templates 1106 may exist within adaptive layout style “A” 1103A and, therefore, the adaptive layout style “A” 1103A is not limited to the two adaptive templates 1106A₁, 1106A_{N} as shown in FIG. 11. Similarly, the ellipsis between adaptive template “Z₁” 1106Z₁and adaptive template “Z_{N}” 1106Z_{N} illustrates that a plurality of adaptive templates 1106 may exist within adaptive layout style “Z” 1103Z and, therefore is not limited to the two templates 1106Z₁, 1106Z_{N} as shown in FIG. 11. Additionally, one adaptive layout style 1103A may comprise a different number of adaptive templates 1106 than another adaptive layout style 1103Z.

The adaptive layout styles 1103 are stored in the template storage unit 908. Each adaptive layout 1103 identifies a set of templates 1106 associated therewith. The ellipsis between adaptive layout style “A” 1103A and adaptive layout style “Z” 1103Z illustrates that a plurality of adaptive layout styles 1103 may exist within the template storage unit 908 and, therefore, is not limited to the two adaptive layout styles 1103A, 1103Z as shown in FIG. 11. For example and not limitation, adaptive layout styles 1103 and adaptive templates 1106 may be represented within the claimed subject matter by XML.

FIG. 12 displays a block diagram representation of an adaptive template 1106 in accordance with an exemplary embodiment of the claimed subject matter. Each adaptive template 1106 within the template storage unit 908 may comprise layout elements 1112, constraint-based relationships 1115 for defining relationships between elements 1112, and preconditions 1109 that characterize the suitability of the template 1106 for the particular content of a document.

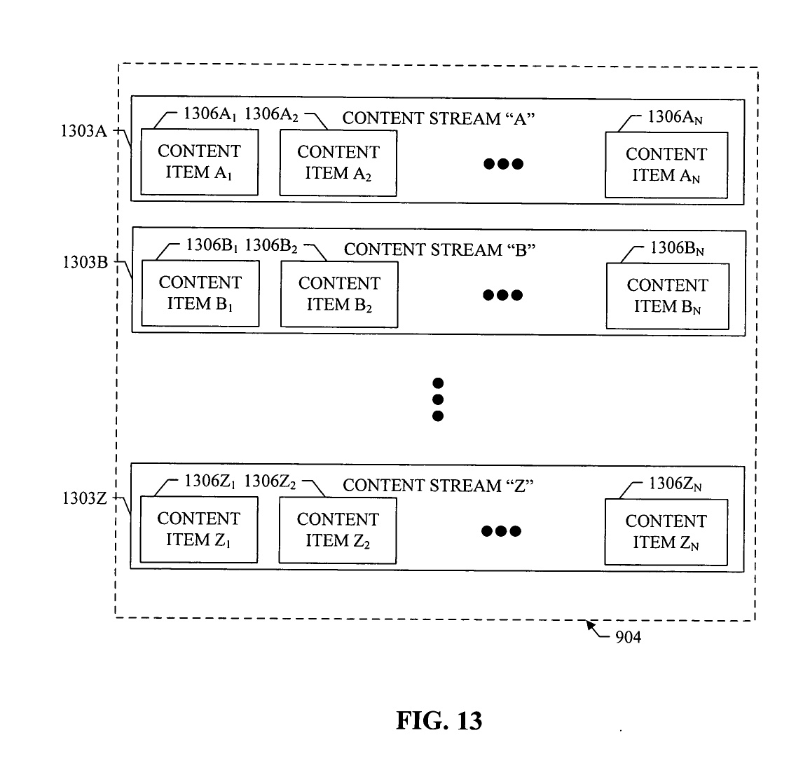

A layout element 1112 represents a particular region within the page of the template 1106 in which content may be placed. Typically, the elements 1112 within a grid-based document layout are rectangular regions of the template 1106 page. Each layout element 1112 comprises a specified source stream variable 1209, element z-order placement variable 1212, and layout templates variable 1215. The specified source stream variable 1209 specifies which content may be used within the element 1112. For example and not limitation, the specified source stream variable 1209 may specify that only an image may be placed within the element 1112 of the templale an alternative embodiment of the claimed subject matter, multiple elements 1112 use content from the same content stream 1303 (described below with reference to FIG. 13). In such an arrangement, a flow is established and the content of the content stream 1303 is distributed from one element 1112A₁ to the next element 1112A₂.

The element z-order placement variable 1212 of an element 1112 allows each element 1112 to specify its place in an element 1112 z-order. Generally, elements 1112 that are higher in the z-order sit atop lower elements 1112 within the document layout and, consequently, the area region of the higher elements 1112 is subtracted from the area region of the elements 1112 underneath. In effect, the element z-order placement variable 1212 enables grid-based page designs to have overlapping elements 1112, or regions that appear to cut out other elements' 1112 regions. For example, the text in a document layout may flow around a figure. The figure is in a higher z-order than the text and, thus, the figure seems to cut out some of the region reserved for the text. Wrapping text around a figure or image is a technique used within grid-based document layouts.

The layout templates variable 1215 allows each element 1112 to specify a layout template 1106 (or a collection of layout templates 1106) that may be used to layout content atoms. A content atom comprises a content item 1306 that is made up of multiple content streams 1303 (e.g., text, figures, or images). More specifically, a content atom comprises a logical grouping of content which contains one or more elements 1112 content streams 1303 of one or more content types, all of which are considered to be a single item in some parent content item 1306. For example and not limitation, the element 1112 may represent a sidebar which includes text, figures, and images. Through the layout templates variable 1215, the template 1106 may support fully recursive layout and, thus, may support everything from a figure/caption combination to recursive embedding of content.

The constraint-based relationships 1115 (e.g., sometimes referred to herein as “constraints 1115”) of a template 1106 may be used to at least partially define the relationships between elements 1112. The size and placement of each element 1112 in a template 1106 is determined by evaluating a set of interdependent constraint-based relationships 1115 that, when considered together, form a directed acyclic graph. The constraint-based relationships 1115 comprise constraint input variables 1218 and constraint output variables 1221 whose values are determined by a mathematical expression in terms of other constraint variables 1218, 1221. Additionally, the constraint-based relationships 1115 comprise constraint internal variables 1224 whose values may be used when computing values for the constraint output variables 1221. One skilled in the art will recognize that this type of configuration is known as a “one-way constraint system.” In the exemplary embodiment of the claimed subject matter, however, each template 1106 encodes two-dimensional relationships among layout elements 1112 as constraints 1115 that must be resolved to evaluate a particular layout.

The constraint input variables 1218 instruct the template 1106 about the context in which the template 1106 will be used. For example and not limitation, the constraint input variables 1218 may indicate the width and height dimensions of the template 1106 or an element 1112 within the template 1106. Additionally, the constraint input variable 1218 may include custom attributes (e.g., attributes defined by a user through the template authoring tool 910) regarding the document content. In aspects of the claimed subject matter, a constraint system (not shown) may be represented by a pool of constraints that may be used as constraint input variables 1218 and constraint output variables 1221. When custom attributes are present within the document content 904, the custom attributes may be added as additional variables within the constraint system. The constraint output variables 1221 represent various document output attributes including, but not limited to, the rectangular boundary of each element 1112 and the score of the template 1106 which allows a template 1106 to express its fitness in terms of the content to be inserted within the template 1106 (described in more detail below with reference to FIG. 10).

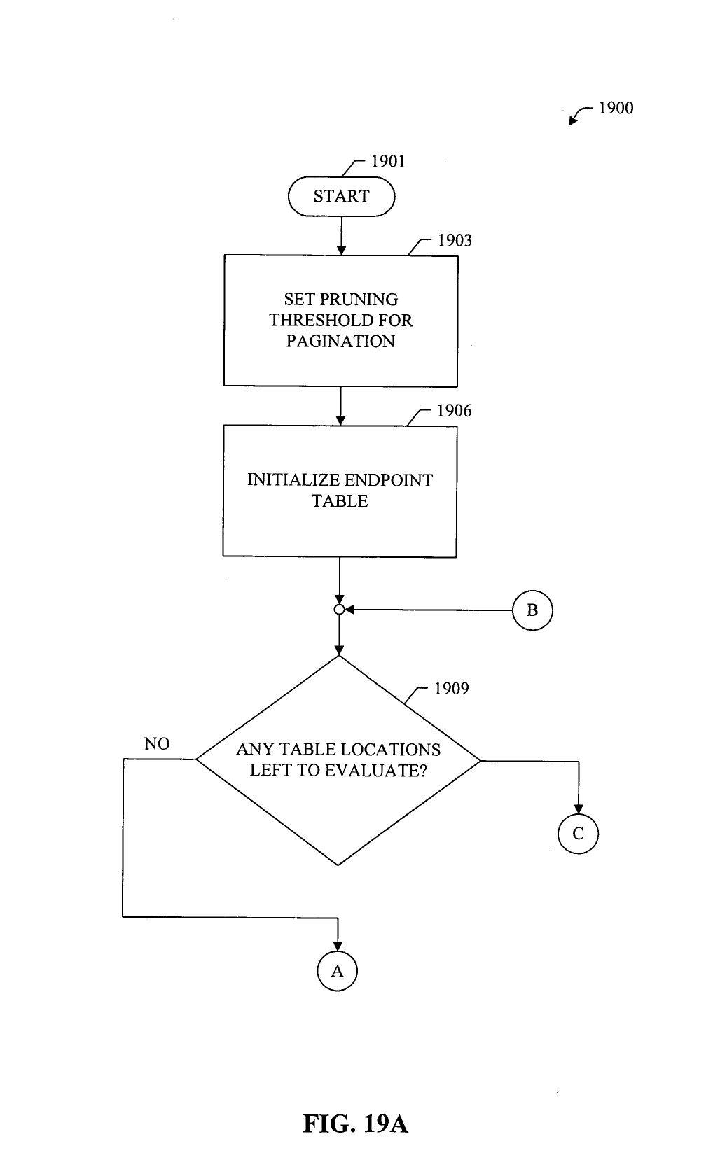

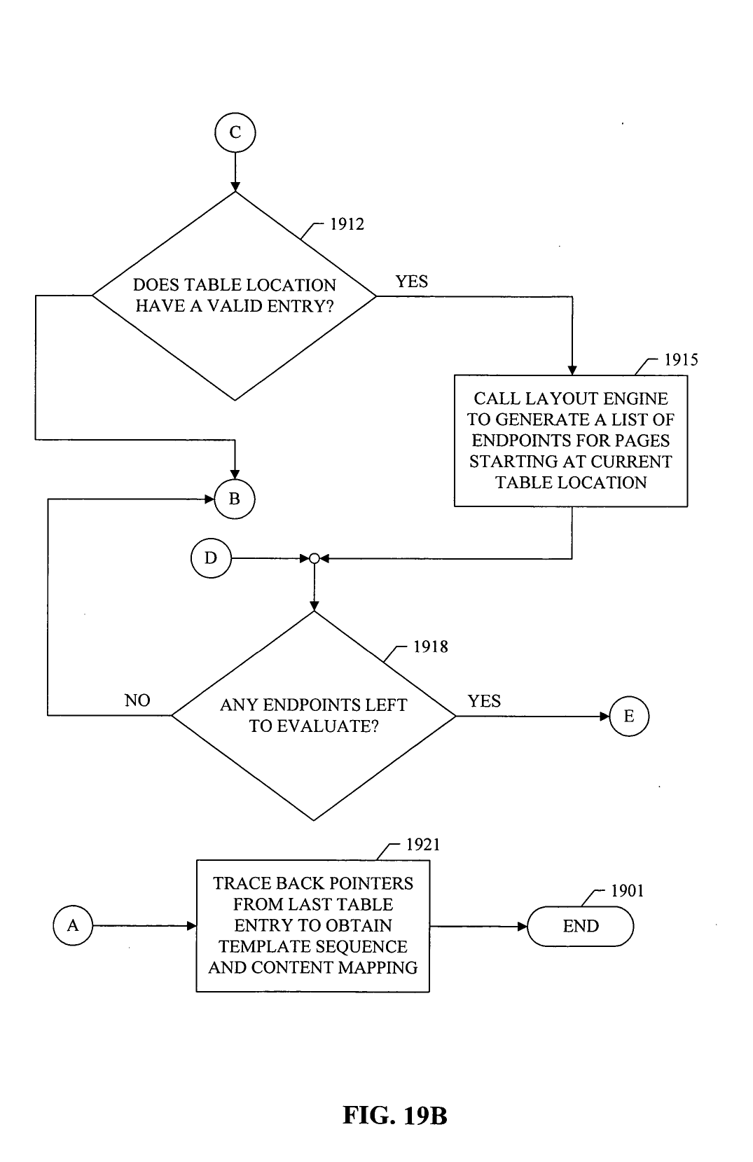

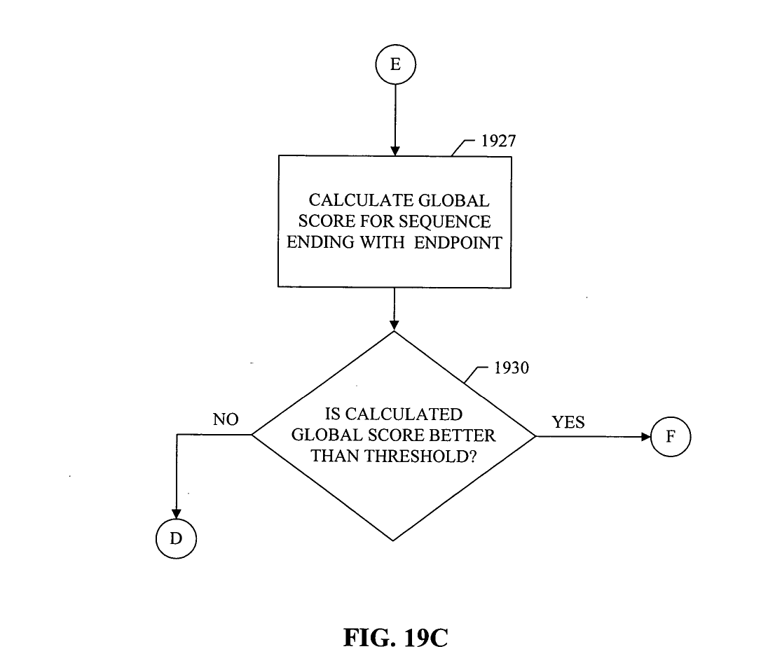

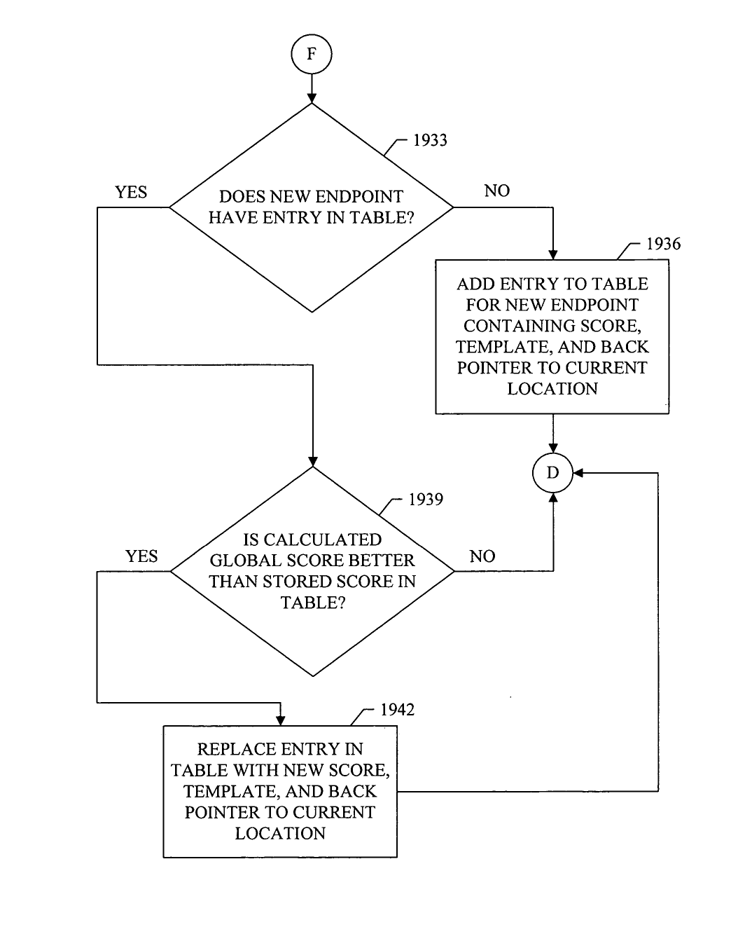

The preconditions 1109 of a template 1106 at least partially characterize the suitability of the template 1106 or the particular content of a document. Each template 1106 uses preconditions 1109to express when the template 1106 is valid when applied to the document content. For example, a template 1106 may be valid if the template 1106 ay be successfully applied to the document content. One skilled in the art will recognize that different preconditions may be used to determine which templates 1106 re valid and which template 1106 are invalid. The adaptive grid-based document layout system 902 uses the preconditions 1109 during pagination (described in more detail below with reference to FIG. 19). The preconditions 1109 may comprise one or more content preconditions variables 1203 and/or one or more value preconditions variables 1206. A content preconditions variable 1203 indicates the amount of content from a given content stream 1303 that must be present to adequately fill the template 1106 or an element 1112 within the template 1106. The value preconditions variable 1206 indicates the range of values that a given constraint variable 1218, 1221 must fall between. For example and not limitation, the content preconditions variable 1203 and the value preconditions variable 1206 may indicate that a particular template 1106 is valid if the document content contains exactly two figures available for display and if the page dimensions of the document content fall somewhere between standard letter and A4 page dimensions.

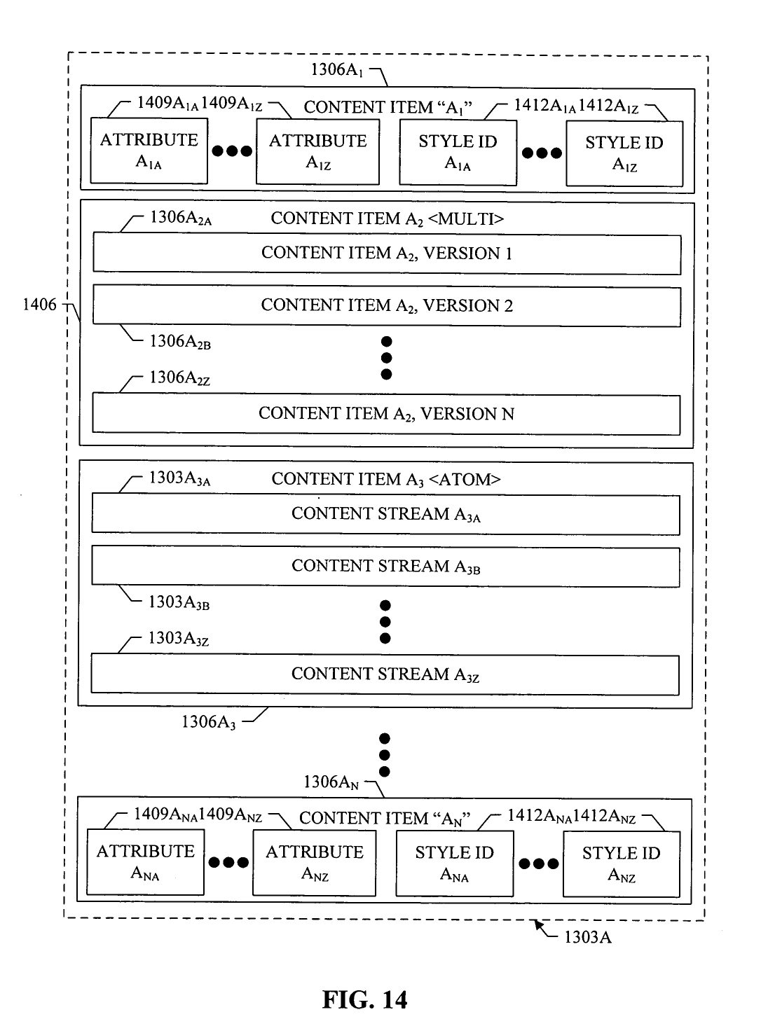

FIG. 13 displays a block diagram representation of a document content 904 including content streams 1303 in accordance with an exemplary embodiment of the claimed subject matter. Document content 904 is represented within the subject invention as a set of individual content streams 1303, each of which contains content that is laid out sequentially. Content streams 1303 represent different, logically independent parts of the document including, but not limited to, body text, sidebars, figures, pull quotes, and photo credits. Content streams 1303 comprise content items 1306 which are described more fully below with reference to FIG. 14. As illustrated by the ellipsis, the document content 904 is not limited to the number of content streams 1303A, 1303B, 1303Z shown in FIG. 13. Similarly, the ellipses illustrate that a content stream 1303A is not limited to the number of content items 1306A₁, 1306A₂, 1306A_{N} shown in FIG. 13.

FIG. 14 displays a block diagram representation of a content stream 1303 including content items 1306 in accordance with an exemplary embodiment of the claimed subject matter. As described above with reference to FIG. 13, content streams 1303 comprise content items 1306. Content items 1306 include, but are not limited to, text, images, audio, video, and other appropriate content types. Each content item 1306 is associated with standard markup (e.g., XML) to indicate structure. In addition to the standard markup, each content item 1306 may be annotated with custom attributes 1409 that alter the way the content item 1306 is treated by the low level engine 502 and templates 1106. For example and not limitation, a content item 1306 representing an image may have an attribute 1409 that signifies the image's importance within the document layout. Accordingly, the low level engine 502 utilizing the content item 1306 within a template 1106 may check the attribute 1409 value to determine how large to make the image in the final layout. The ellipsis between attribute “A_{1A}” 1409A_{1A} and attribute “A_{1Z}” 1409A_{1Z} illustrates that a plurality of attributes 1409 may exist within the content item “A₁” 1306A₁ and, therefore, the content item “A₁” 1306A₁ is not limited to the two attributes 1409A_{1A}, 1409A_{1Z} as shown in FIG. 14. Similarly, the ellipsis between attribute “A_{NA}” 1409A_{NA} and attribute “A_{NZ}” 1409A_{NZ} illustrates that a plurality of attributes 1409 may exist within the content item “A_{N}” 1306A_{N} and, therefore, the content stream “A_{N}” 1306A_{N} is not limited to the two attributes 1409A_{NA}, ^{1409A}_{NZ} as shown in FIG. 14.

In the exemplary embodiment of the claimed subject matter, text content items 1306A₁ may include style identifiers 1412A_{1A}, 1412A_{1Z} to specify the styling of the text within the document content 904. Style identifiers 1412 are typically represented by a stylesheet language such as, but not limited to, cascading style sheets (CSS) or extensible style language (XSL). One skilled in the art will recognize that a stylesheet language enables a user to define how different text elements will appear within a document (e.g., font, font style, and font size). Accordingly, the style identifiers 1412 may be associated with formatting rules in a separate stylesheet file, which is stored in the style sheets storage unit 906. The ellipsis between style identifier “A_{1A}” 1412A_{1A} and style identifier “A_{1Z}” 1412A_{1Z} illustrates that a plurality of style identifiers 1412 may exist within the content item “A₁” 1306A₁ and, therefore, the content item “A₁” 1306A₁ is not limited to the two style identifier s 1412A_{1A}, 1412A_{1Z} as shown in FIG. 14. Similarly, the ellipsis between style identifier “A_{NA}” 1412A_{NA} and style identifier “A_{NZ}” 1412A_{NZ} illustrates that a plurality of style identifier s 1412 may exist within the content item “A_{N}” 1306A_{N} and, therefore, the content item “A_{N}” 1306A_{N} is not limited to the two style identifier s 1412A_{NA}, 1412A_{NZ} shown in FIG. 14.

Content items 1306 may also be encoded to include multiple versions 1306A_{2A}, 1306A_{2B}, 1306A_{2Z} of any piece of content. Each of the different content item versions 1306A_{2A}, 1306A_{2B}, 1306A_{2Z} are packaged inside a <multi> tag 1406. During document layout, the adaptive grid-based document layout system 902 chooses one of the versions to use when formatting the page with a template 1106. To assist the adaptive grid-based document layout system 902, each of the different content item versions 1306A_{2A}, 1306A_{2B}, 1306A_{2Z} may comprise attributes 1409 that suggest the most appropriate use of each particular content item version 1306A_{2A}, 1306A_{2B}, 1306A_{2Z}. For example and not limitation, a first version of content item “A₂” 1306A_{2A} may indicate that the first version of the content item 1306A_{2A} is best used in a “summary” section, while a second version of content item “A₂” 1306A_{2B} may indicate that the second version of the content item 1306A_{2B} is best used in a sidebar. A template 1106 may choose the appropriate content item version 1306A_{2A}, 1306A_{2B}, 1306A_{2Z} based on how the template 1106 intends to format the document content. If no attributes 1409 exist to define the different versions of a content item 1306, then the adaptive grid-based document layout system 902 is free to choose the version that works best for the format of the current page or document. The ellipsis between the second version of content item “A₂” 1306A_{2B} and the nth version of content item “A₂” 1306A_{2Z} illustrates that a plurality of content item 1306 versions may exist within the <multi> tag 1406 and, therefore, the <multi> tag 1406 is not limited to the three content item versions 1306A_{2A}, 1306A_{2B}, 1306A_{2Z} as shown in FIG. 14.

Content streams 1303A_{3A}, 1303A_{3B}, 1303A_{3Z} may also be nested hierarchically within a parent content item 1306A₃ using an <atom> tag which groups a collection of content streams 1303A_{3A}, 1303A_{3B}, 1303A_{3Z} together as a content atom within a parent content item 1306A₃. The collection of content streams 1303A_{3A}, 1303A_{3B}, 1303A_{3Z} is then treated as a single content item 1306A₃. Document elements such as a sidebar are inherently represented by multiple document elements (e.g., text, figures, caption, and footer). The <atom> tag permits multiple content streams 1303 to be treated as one single item of content for document layout purposes. For example and not limitation, an <atom> tag may group a “title” content stream 1303, “figure” content stream 1303, “figure caption” content stream 1303, “descriptive text” content stream 1303, and “footer” content stream 1303 within a parent “sidebar” content item 1306. The ellipsis between content stream 1303A_{3B} and content stream 1303A_{3Z} illustrates that a plurality of content streams 1303 may exist within a parent content item 1306A₃ and, therefore, the parent content item 1306A₃ is not limited to the three content streams 1303A_{3A}, 1303A_{3B}, 1303A_{3Z} as shown in FIG. 14.

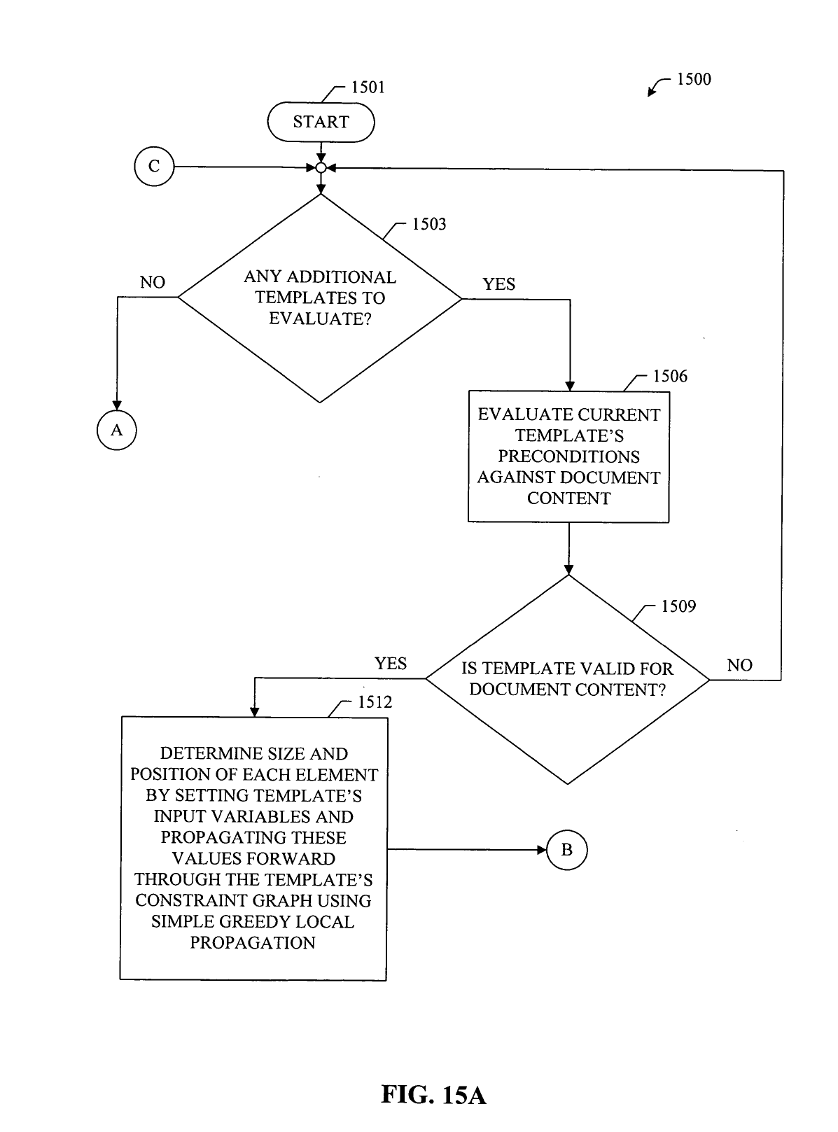

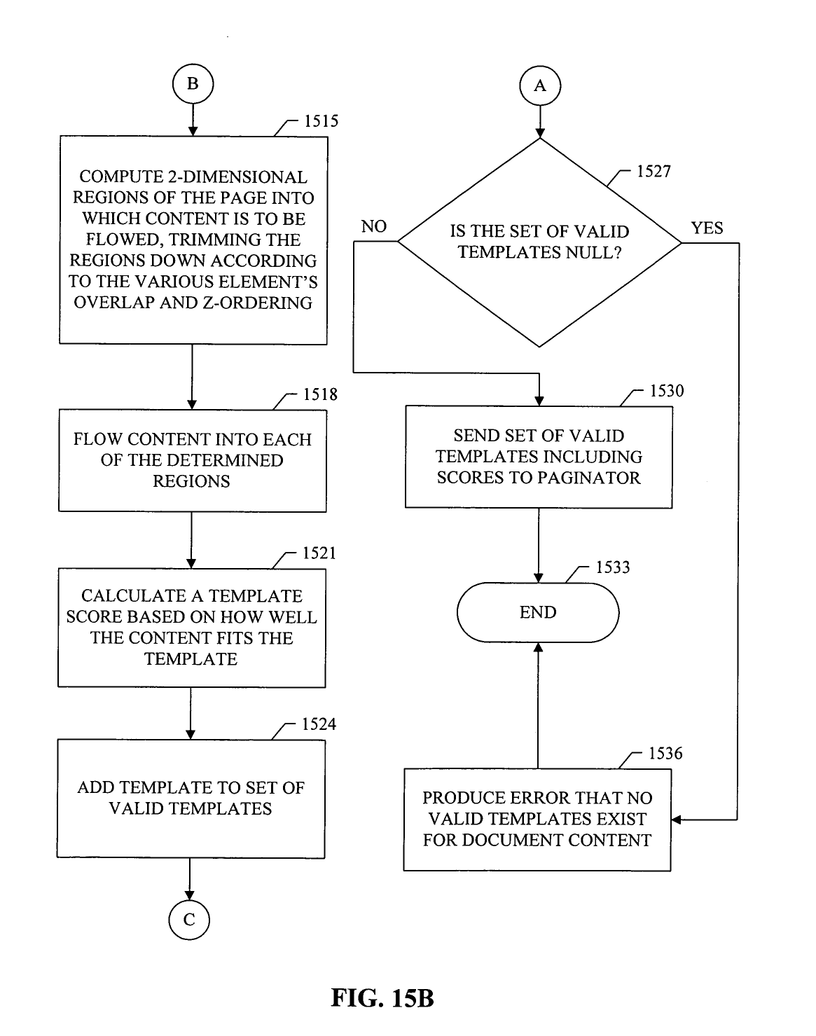

FIGS. 15A-15B display a flowchart representation of a method 1500 of applying document content 904 to templates 1106 in accordance with an exemplary embodiment of the claimed subject matter. The low level engine 502 combines the document content 904 received from the paginator 602 with the templates 1106 from the template storage unit 908 and the style sheets from the style sheets storage unit 906. The result is a collection of potential page layouts that define the document's layout style.

After starting at step 1501, the low level engine 502 proceeds to step 1503 where the low level engine 502 determines whether additional templates 1106 need to be evaluated using the document content 904. Initially, none of the templates 1106 within the template storage unit 908 will have been evaluated. As step 1503 is repeated, however, the low level engine 502 will consider other templates 1106 available within the template storage unit 908 until all of the templates 1106 have been considered. Alternatively, the low level engine 502 evaluates all of the templates 1106 within a data structure (e.g., an array or vector) provided by the paginator 602 to step 1503(not shown), instead of all of the templates 1106 within the template storage until step 1503, the low level engine 502 determines that no additional templates 1106 need to be evaluated, then the low level engine 502 proceeds to step 1527, described below. If, however, at step 1503, the low level engine 502 determines that an additional template 11evaluated, then the low level engine 502 proceeds to step 1506 where the preconditions 1109 of the template 1106currently being considered (e.g., also referred to herein as “current template 1106”) are evaluated against the document content 904. Next, at step 1509, the low level engine 502 determines whether the current template 1106 is valid for the document content 904 being considered.

If at step 1509, the low level engine 502 determines that the current template 1106 is not valid for the document content 904 being considered, then the low level engine 502 proceeds to step 1503, described above. If, however, at step 1509, the low level engine 502 determines that the current template 1106 is valid for the document content 904 being considered, then the low level engine 502 proceeds to step 1512 where the low level engine 502 determines the size and position of each element 1112 of the template 1106 by setting the current template's input variables 12 18 and propagating these values forward through the current template's constraint graph using simple greedy local propagation.

Then, at step 1515, the low level engine 502 computes the two-dimensional regions of the layout page to be generated by the template 1106 and into which the document content 904 will be flowed. Additionally, the low level engine 502 trims down the regions according to any overlap between elements 1112 or based on element z-order placement variables 1212. Next, at step 1518, the low level engine 502 flows document content 904 into each of the determined regions. The low level engine 502 then proceeds to step 1521 where the low level engine 502 calculates a template score for the template 1106 based on how well the document content 904 fits the template 1106 (described in more detail below with reference to FIG. 10). Next, at step 1524, the low level engine 502 adds the template 1106 to a set or sequence of valid templates 1106. The low level engine 502 then proceeds to step 1503, described above.

As described above, if the low level engine 502 at step 1503 determines that no additional templates 1106 need to be evaluated, then the low level engine 502 proceeds to step 1527 where the low level engine 502 determines if the set of valid templates 1106 is empty. If, at step 1527, the low level engine 502 determines that the set of valid templates 1106 is empty, then the low level engine 502 proceeds to step 1536 where the low level engine 502 produces an error that no valid set of templates 1106 exists for the document content 904. The low level engine 502 then terminates operation in accordance with method 1500 at step 1533. If, however, at step 1527 the low level engine 502 determines that a set of valid templates 1106 exists, then the low level engine 502 proceeds to step 1530 where the low level engine 502 sends the set of valid templates 1106 and corresponding scores to the paginator 602. The low level engine 502 then terminates operation in accordance with method 1500 at step 1533.

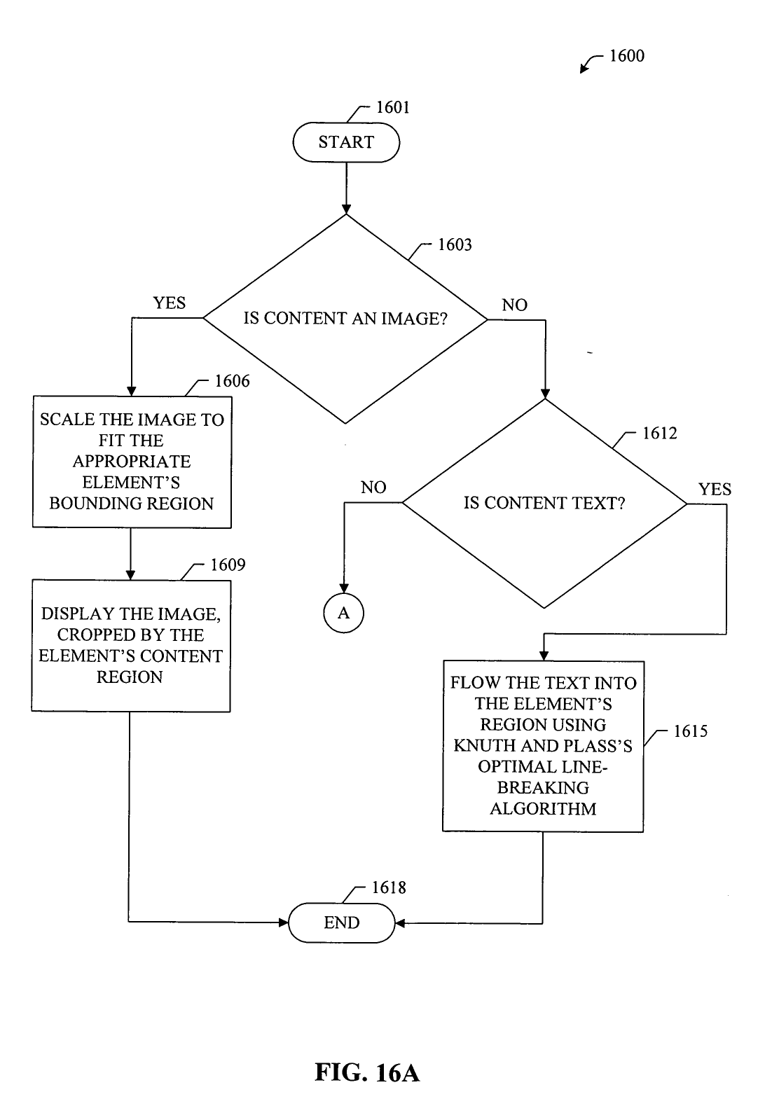

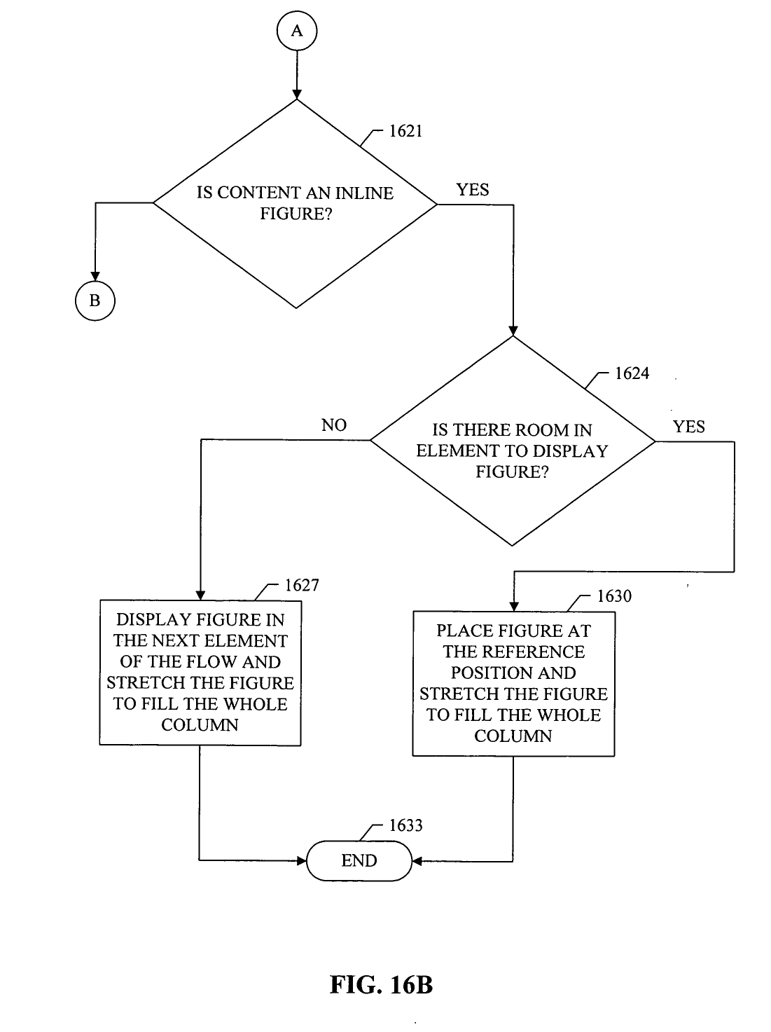

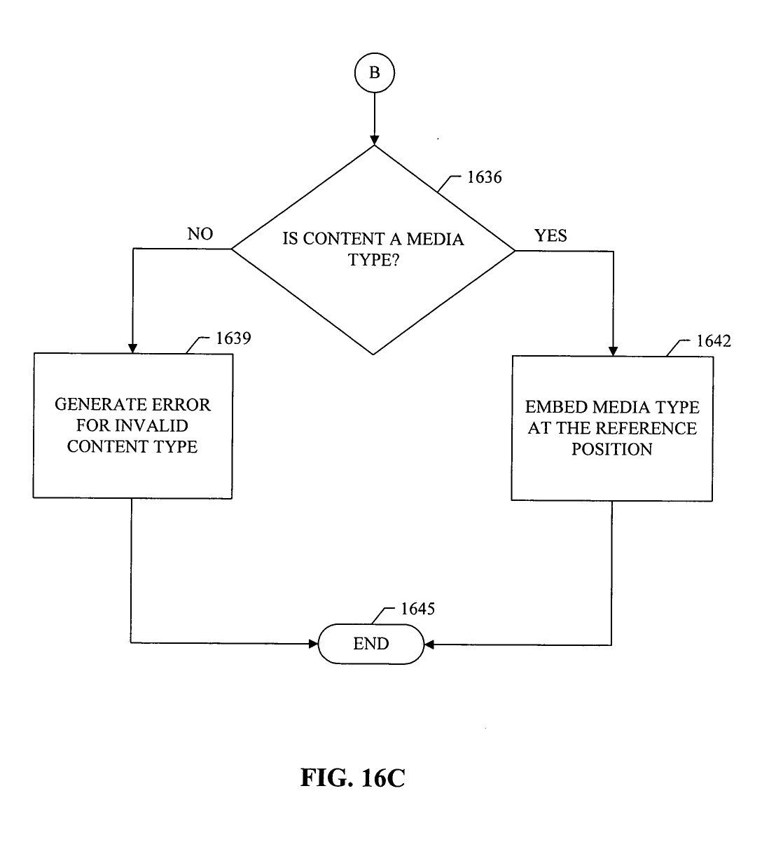

FIGS. 16A-16C display a flowchart representation of a method 1600 of flowing content into elements 1112 within the document layout in accordance with an exemplary embodiment of the claimed subject matter. The low level engine 502 controls the flow of content into element regions according to content type. Generally, content type includes, but is not limited to, images, text, inline figures, and media.

After starting at step 1601, the low level engine 502 proceeds to step 1603 where the low level engine 502 determines whether the content type is an image. If, at step 1603, the low level engine 502 determines that the content type is an image, then the low level engine 502 proceeds to step 1606 where the low level engine 502 scales the image to fit the bounding region of the appropriate element 1112. Next, at step 1609, the low level engine 502 displays the image that has been cropped by the content region of the element 1112. The low level engine 502 then terminates operation in accordance with method 1600 at step 1618.

If, however, at step 1603 the low level engine 502 determines that the content type is not an image, the low level engine 502 proceeds to step 1612 where the low level engine 502 determines whether the content type is text. If, at step 1612, the low level engine 502 determines that the content type is text, then the low level engine 502 proceeds to step 1615 where the low level engine 502 permits the text to flow into the bounding region of the element 1112 using a line-breaking algorithm such as, but not limited to, Knuth and Plass's optimal line-breaking algorithm. The low level engine 502 then terminates operation in accordance with method 1600 at step 1618.

If, however, at step 1612 the low level engine 502 determines that the content type is not text, then the low level engine 502 proceeds to step 1621 where the low level engine 502 determines whether the content type is an inline figure (e.g., figures that occur within the flow of text). If, at step 1621, the low level engine 502 determines that the content type is an inline figure, the low level engine 502 proceeds to step 1624 where the low level engine 502 determines whether there is room in the bounding region of the element 1112 to display the figure. If, at step 1624, the low level engine 502 determines that there is room in the bounding region of the element 1112 to display the figure, then the low level engine 502 proceeds to step 1630 where the low level engine 502 places the figure at the specified reference position and resizes the figure to fill the whole column of the element 1112. The low level engine 502 then terminates operation in accordance with method 1600 at step 1633. Otherwise, if the low level engine 502, at step 1624, determines that the bounding region of the element 1112 is not of sufficient size to display the figure, then the low level engine 502 proceeds to step 1627 where the low level engine 502 displays the figure in the next element 1112 of the flow and resizes the figure to fill the whole column of the next element 1112. The low level engine 502 then terminates operation in accordance with method 1600 at step 1633.

If, however, at step 1621 the low level engine 502 determines that the content type is not an inline figure, then the low level engine 502 proceeds to step 1636 where the low level engine 502 determines whether the content type is media. If, at step 1636, the low level engine 502 determines that the content type is media, then the low level engine 502 proceeds to step 1642 where the low level engine 502 embeds the media type at the specified reference position. The low level engine 502 then terminates operation in accordance with method 1600 at step 1645. Otherwise, if the low level engine 502, at step 1636, determines that the content type is not media, then the low level engine 502 proceeds to step 1639 where the low level engine 502 generates an error indicating an invalid content type. The low level engine 502 then terminates operation in accordance with method 1600 at step 1645.

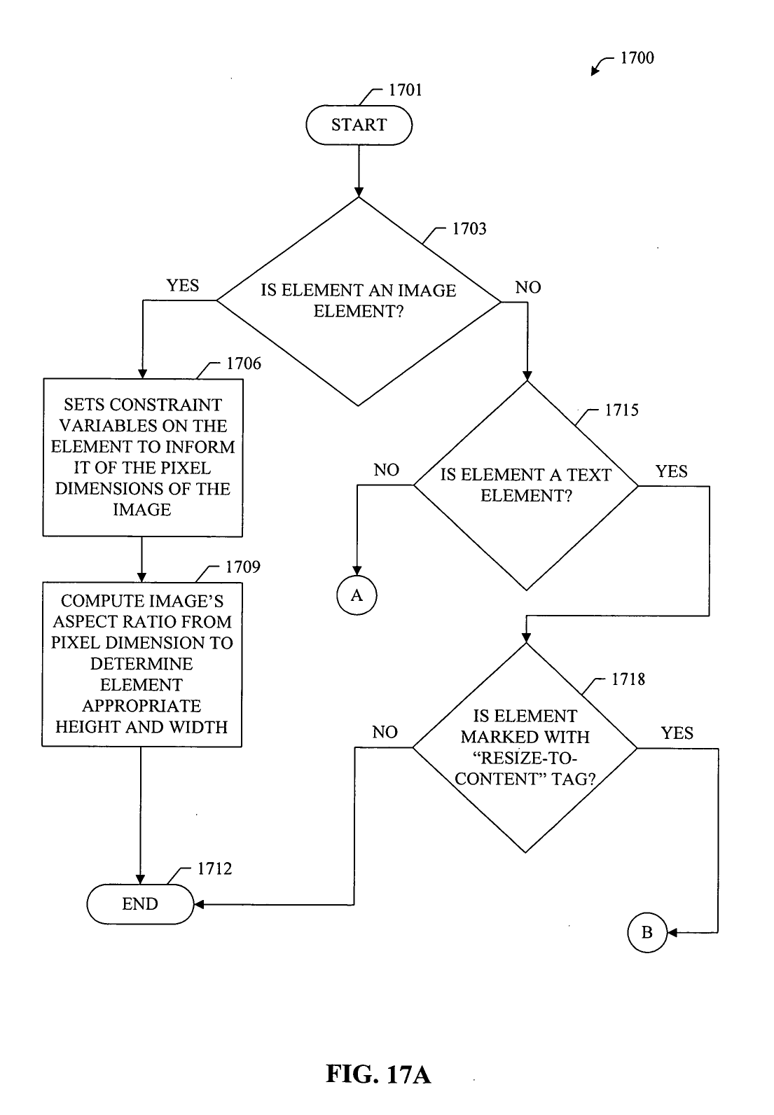

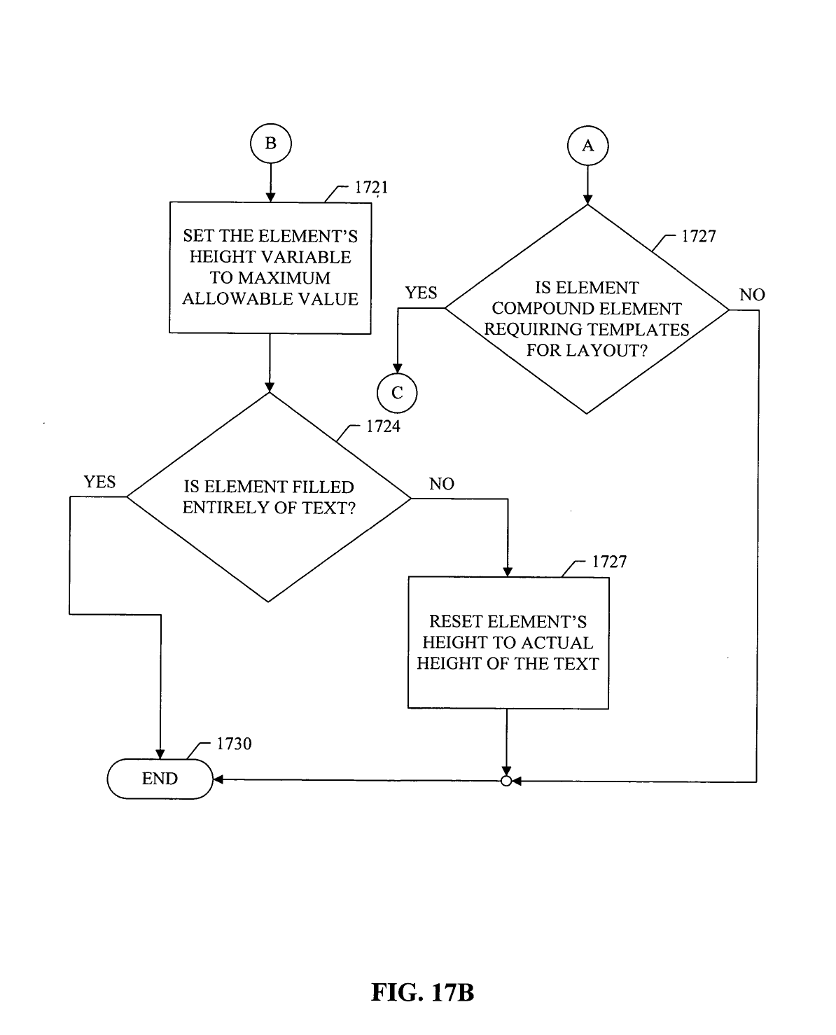

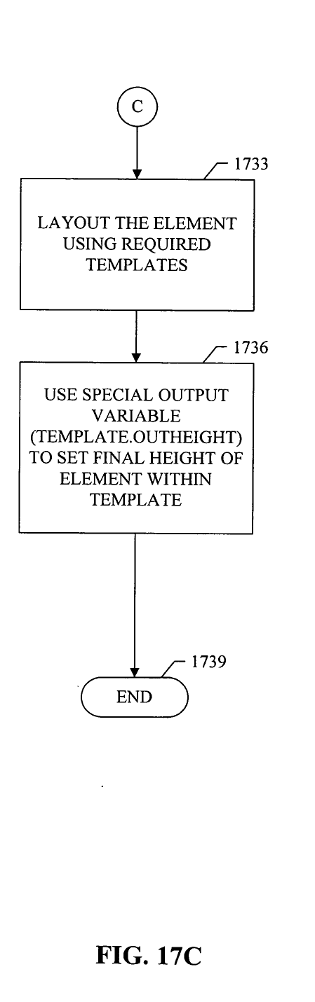

FIGS. 17A-17C display flowchart representations of a method 1700 of self-sizing elements 1112 within the document layout in accordance with an exemplary embodiment of the claimed subject matter. The low level engine 502 supports elements 1112 that automatically adjust their height to fit the document content 904. The automatic resizing of elements 1112 depends on the content type.

After starting at step 1701, the low level engine 502 proceeds to step 1703 where the low level engine 502 determines whether the element 1112 is an image element. If, at step 1703, the low level engine 502 determines that the element 1112 is an image element, then the low level engine 502 proceeds to step 1706 where the low level engine 502 sets the constraint variables 1218, 1221 associated with the element 1112 in order to provide the element 1112 with the pixel dimensions of the image. Next, at step 1709, the low level engine 502 computes the image's aspect ratio from the pixel dimensions to determine the appropriate height and width of the element 1112. The low level engine 502 then terminates operation in accordance with method 1700 at step 1712.

If, however, at step 1703 the low level engine 502 determines that the element 1112 is not an image element, then the low level engine 502 proceeds to step 1715 where the low level engine 502 determines whether the element 1112 is a text element. If, at step 1715, the low level engine 502 determines that the element 1112 is a text element, then the low level engine 502 proceeds to step 1718 where the low level engine 502 determines whether the element 1112 comprises a predetermined mark or attribute, such as, but not limited to a “resize-to-content” tag. If, at step 1718, the low level engine 502 determines that the element 1112 is not marked with a “resize-to-content” tag, then the low level engine 502 terminates operation in accordance with method 1700 at step 1712, because no resizing of the element 1112 is necessary.

If the low level engine 502, at step 1718, determines that the element 1112 is marked with a “resize-to-content” tag, then the low level engine 502 proceeds to step 1721 where the low level engine 502 sets the height variable of the element 1112 to the maximum allowable value. Next, at step 1724, the low level engine 502 determines whether the element 1112 is filled entirely with text. If, at step 1724, the low level engine 502 determines that the element 1112 is filled entirely with text, then the low level engine 502 terminates operation in accordance with method 1700 at step 1730, because no resizing of the element 1112 is necessary. If, however, at step 1724 the low level engine 502 determines that the element 1112 is not filled entirely with text, then the low level engine 502 proceeds to step 1727 where the low level engine 502 resets the height of the element 1112 to the actual height of the text. The low level engine 502 then terminates operation in accordance with method 1700 at step 1730.

If, however, the low level engine 502 determines that element 1112 is not a text element at step 1715, then the low level engine 502 proceeds to step 1727 where the low level engine 502 determines whether the element 1112 is a compound element requiring templates 1106 for layout. A content atom represents two or more pieces of content that, taken together, are considered to be an atomic unit. For example and not limitation, a picture and corresponding caption are conceptually grouped together as a single “captioned figure.” Accordingly, a compound element is an element in a a template that may accept a content atom. In order to layout the separate pieces of sub-content inside the content atom, the compound element specifies a separate sub-template that may be used to arrange the separate subparts of the content atom on the layout page. If, at step 1727, the low level engine 502 determines that the element 1112 is not a compound element requiring templates 1106 for layout, then the low level engine 502 terminates operation in accordance with method 1700 at step 1730, because no resizing is required.

If, however, at step 1727, the low level engine 502 determines that the element 1112 is a compound element requiring templates 1106 for layout, then the low level engine 502 proceeds to step 1733 where the low level engine 502 uses the required templates 1106 to layout the element 1112. A compound element may include multiple content items 1306 or multiple content streams 1303, such as, but not limited to, a content atom 1306A₃. Then, the low level engine 502 proceeds to step 1736 where the low level engine 502 uses the special output variable 1221 to set the final height of the element 1112 within the template 1106. The low level engine 502 then terminates operation in accordance with method 1700 at step 1739.

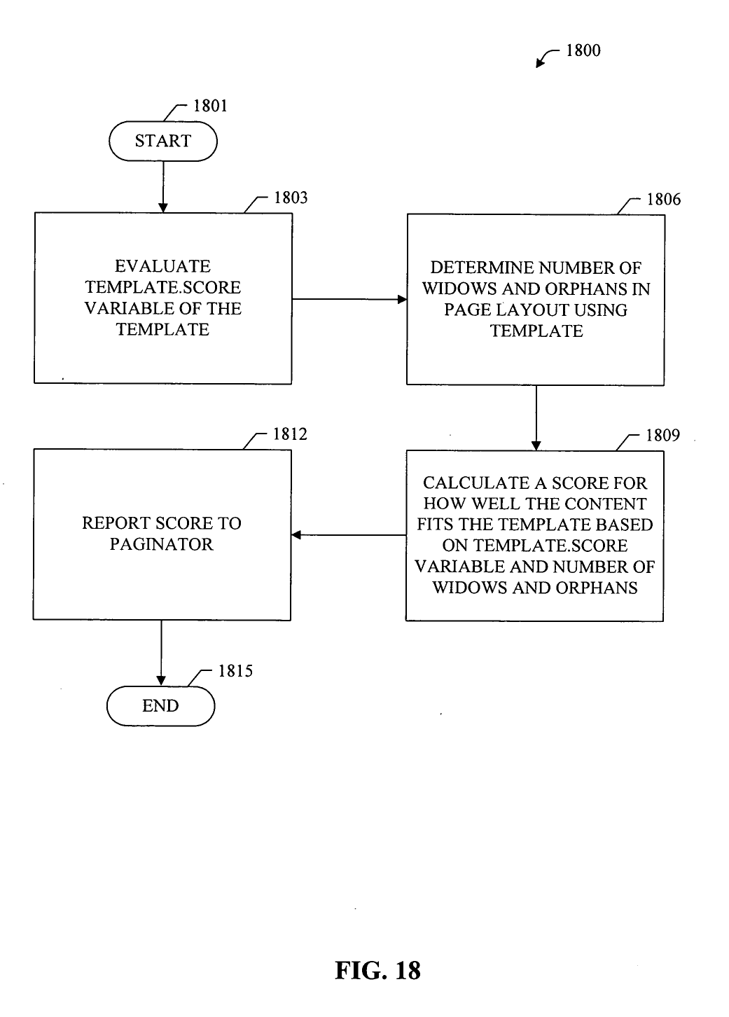

FIG. 18 displays a flowchart representation of a method 1800 of scoring a template 1106 based on how well the document content 904 fits the template 1106 in accordance with an exemplary embodiment of the claimed subject matter. For each template 1106 used to layout document content 904, the low level engine 502 calculates a score based on how well the content fits the template 1106. Once the low level engine 502 calculates the scores for all of the potential templates 1106, the low level engine 502 reports the scores back to the paginator 602 which may use the scores, along with template scores for previous and subsequent pages of content, to calculate an optimal sequence of templates 1106 to use for paginating all of the document content 904.

After starting at step 1801, the low level engine 502 proceeds to step 1803 where the low level engine 502 evaluates a constraint output variable 1221 comprising a template score of the template 1106. The low level engine 502 then proceeds to step 1806 where the low level engine 502 determines the number of widows and orphans within the page layout after applying the template 1106. Then, at step 1809, the low level engine 502 calculates a score for how well the content fits the template 1106, whereby the quality score is based on the template. score variable and the number of widows and orphans in the page layout. The low level engine 502 proceeds to step 1812 where the low level engine 502 provides the paginator 602 with the calculated score of the template 1106, which the paginator 602 uses in its calculation of the final sequence of templates 1106. The paginator 602 then terminates operation in accordance with method 1800 at step 1815.

The paginator 602 produces a sequence of templates 1106 and a mapping of document content 904 to each template 1106 in the sequence which the low level engine 502 may use to display an entire document. In an embodiment of the claimed subject matter, the adaptive grid-based document system 902 utilizes multiple pagination algorithms for different applications. Accordingly, the adaptive grid-based document system 902 may comprise a first paginator 602 that quickly produces a valid pagination for interactive adaptation and a second paginator 602 that produces an optimal pagination, but requires more time to operate. The first paginator 602 might use a “greedy” algorithm that always uses the first template 1106 for each page that will accept the content at the current location in the document or might choose the single best template 1106 at each place in the sequence without evaluating the global consequences (e.g., global scoring) of the choice. The second paginator 602 might use techniques including, but not limited to, creating approximate optimal paginations superior to a “greedy” pagination, but not guaranteed to be optimal, by running a series of smaller optimization processes over smaller portions (e.g., “windows”) of the document content 904.

FIGS. 19A-19D display a flowchart representation of a method 1900 of optimally paginating document content 904 into an adaptive grid-based document layout in accordance with an exemplary embodiment of the claimed subject matter. In order to find an optimal pagination, the paginator 602 must measure the effectiveness of each sequence of valid templates 1106, whereby the measure is maximized by a systematic or heuristic search or by constraint optimization. An optimizing paginator 602 produces a sequence of templates 1106 and a mapping of content onto each template 1106, which maximizes some measure of quality. For example and not limitation, one such measure includes the “total page turns” metric, which counts the total number of page turns that would be required to both read through the text and turn to any additional content referenced by the text. In the exemplary embodiment of the claimed subject matter, a metric used to score the effectiveness of each sequence of valid templates 1106 includes the use of the total number of page turns value with other measures that reflect the quality of the appearance of the page (e.g., empty spaces, aesthetic look, workability, or readability).

As the basic dynamic programming algorithm used to evaluate subproblems (e.g., new templates 1106 in a series) relies on hindsight to score sequences of subproblems, an aspect of the claimed subject matter restructures the algorithm so that the evaluation is performed only for valid pages by calculating all possible endpoints of a current subproblem (e.g., forward-looking). An aspect of the claimed subject matter ensures that when a new subproblem is considered, all subproblems that could possibly precede it in a solution will have already been solved, and the entry pointing back to the optimal predecessor will be in a data table. Consequently, if no entry in a data table exists for a subproblem when it is reached, then the subproblem may be passed over with no computation.

Additionally, an embodiment of the claimed subject matter may easily be modified to handle additional content streams 1303 by adding extra dimensions to the data table and additional nested loops to the algorithm. Optional content streams 1303 may also be processed with no additional programming by having templates 1106 available that display content from optional content streams 1303. The paginator 602 includes content items 1306 from the optional content streams 1303 whenever they improve the optimal pagination. Such optional content streams 1303 and templates 1106, which use optional content streams 1303, may vastly improve pagination quality.

Performance of various aspects of the claimed subject matter is further improved by pruning partial solutions (e.g., subproblems already verified to be acceptable) from the data table whose quality score is worse than some threshold (e.g., sometimes referred to herein as a “pruning threshold”). Because relatively few acceptable solutions exist, this pruning helps to narrow the list of subproblem sequences down to the most optimal. For example and not limitation, a conservative pruning strategy includes the use of the quality score resulting from a “first-fit” solution (e.g., “greedy” solution) as the pruning threshold. Use of such a conservative pruning strategy typically provides a significant speedup of the pagination process and guarantees that a solution will always be found. Alternatively, an optimistic pruning strategy chooses an approximate, near-perfect threshold and iteratively alters the threshold if no solution is found. When a significant number of templates 1106 exist in the template storage unit 908, the likelihood that a near-perfect solution exists is high and, therefore, the optimistic pruning strategy becomes more effective.

Entries within the data table represent locations in the document (e.g., endpoints of the page currently being processed). Further, an entry in the data table represents the best pagination discovered so far that ends at the given location in the document's various content streams 1303, which may be determined by an index value of the entry in the table. The table entry includes, but is not limited to, the location in the table (and, therefore, the location in the document) of the preceding page in the optimal partial-solution ending at that location, and the template 1106 used to render the last page (e.g., the page between the previous table entry and the table entry currently being processed).

The outermost loop of the process used by embodiments of the claimed subject matter traverses through the table, evaluating larger and larger (partial) solutions or subproblems as it proceeds. Each iteration of the loop calls the low level engine 502 to find the next set of pages (e.g., a page is a template 1106 and a selection of content; there may exist multiple results for a single template 1106 with different amounts of text, different image versions, etc.) which may follow the current endpoint under consideration. The resulting set of pages yields a set of endpoints for the next page, which are then propagated forward by the paginator 602 into the data table (e.g., replacing the existing entries, if the new entry has a better global score).

For example and not limitation, the method 1900 described in FIGS. 19A-19D may be represented by the pseudo-code provided in TABLE 1.

TABLE 1

```
BEGIN PAGINATE;
    Initialize Endpoint Table (place one entry at location (0,0)
    for beginning of document);
    FOR each table location DO:
        IF location contains valid entry THEN:
            CALL LOW LEVEL ENGINE to generate list of
            endpoints for pages starting at current table
            location;
            FOR each endpoint returned (new) DO:
                Calculate global score for sequence ending
                with new endpoint;
                IF score is better than Pruning Threshold
THEN:
                    IF new endpoint has no entry in
table THEN:
                        Add entry for new endpoint
                        containing score, template,
                        and back pointer to location;
                    ELSE (new endpoint does have
                    previous entry in table) THEN:
                        Compare score with existing
                        entry's score in table;
                        IF score is better than
                        existing entry's score THEN:
                            Replace entry in table
                            with new score,
                            template, and back
                            pointer to location;
                        ENDIF;
                    ENDIF;
                ENDIF;
            ENDFOR;
        ENDIF;
    ENDFOR;
    Trace back pointers from last table entry to obtain template
sequence and content mapping;
END PAGINATE;
```

After starting at step 1901, the paginator 602 proceeds to step 1903 where the paginator 602 sets the pruning threshold for optimal pagination. One skilled in the art will recognize that a threshold value may be determined in a variety of ways, including the techniques described above.

Next, at step 1906, the paginator 602 initializes the empty data table with a single endpoint representing the beginning of the first page of the document (e.g., placing one entry at location (0, 0) to represent the beginning of the document). The paginator 602 then proceeds to step 1909 where the paginator 602 determines whether any locations within the table need to be evaluated. If, at step 1909, the paginator 602 determines that no locations within the table need to be evaluated, then the paginator 602 proceeds to step 1921 where the paginator 602 traces the back pointers from the last table entry to obtain the optimal template 1106 sequence and content mapping. The paginator 602 then terminates operation in accordance with method 1900 at step 1901.

If, however, the paginator 602, at step 1909, determines that locations within the table need to be evaluated, then the paginator 602 proceeds to step 1912 where the paginator 602 determines whether the current table location has a valid entry. The current entry is chosen by the paginator from the set of unevaluated table entries for which all entries preceding it in the table have been evaluated. If, at step 1912, the paginator 602 determines that the current table entry does not have a valid entry, then the paginator 602 marks the entry as evaluated and proceeds to step 1909, described above. Otherwise, if the paginator 602, at step 1912, determines that the current table entry has a valid entry (e.g., an acceptable entry representing templates that may be successfully applied to the document content), then the paginator 602 proceeds to step 1915 where the paginator 602 calls the low level engine 502 to generate a list of endpoints for pages starting at the current table location.

Generally, through a call to a program module, the low level engine 502 applies each of the templates 1106 within the template storage unit 908 to the unprocessed portion of the document content 904 to determine which templates 1106 are valid templates 1106. If none of the templates 1106 may be used, then no templates 1106 may follow the current table location and, therefore the current table entry should not be considered any further. When the low level engine 502 determines that a template 1106 may be applied a the current location (e.g., it will accommodate the content beginning at the current table location), then the low level engine 502 applies the template to the content to determine the endpoint and score of the resulting page and includes the endpoint in the list of endpoints returned to the paginator 602, which may determine the appropriate global score associated with the new sequence of templates 1106.

The paginator 602 then proceeds to step 1918 where the paginator 602 determines whether any endpoints returned in step 1915 need to be evaluated (e.g., whether there is a calculated global score for the endpoint). If, at step 1918, the paginator 602 determines that no endpoints need to be evaluated, then the paginator 602 proceeds to step 1909, described above. If, however, the paginator 602, at step 1918, determines that endpoints need to be evaluated, then the paginator 602 proceeds to step 1927 where the paginator 602 calculates the global score for the sequence ending with the new endpoint. The paginator 602 then proceeds to step 1930 where the paginator 602 determines whether the calculated global score is better than the predetermined pruning threshold. If, at step 1930 the paginator 602 determines that the calculated global score is not better than the predetermined pruning threshold, then the paginator 602 proceeds to step 1918, described above.

If, however, the paginator 602, at step 1930, determines that the calculated global score is better than (e.g., greater than) the predetermined pruning threshold, then the paginator 602 proceeds to step 1933 where the paginator 602 determines whether the new endpoint has an entry in the data table. If, at step 1933, the paginator 602 determines that the new endpoint does not have an entry in the data table, then the paginator 602 proceeds to step 1936 where the paginator 602 adds the entry into the table for the new endpoint, containing the calculated global score, current template 1106, and a back pointer to the current location. Then, the paginator 602 proceeds to step 1918, described above.

Otherwise, if the paginator 602, at step 1933, determines that the new endpoint does have an entry in the data table, then the paginator 602 proceeds to step 1939 where the paginator 602 determines whether the calculated global score is better than the score stored in the data table. If, at step 1939, the paginator 602 determines that the calculated global score is not better than the score stored in the data table, then the paginator 602 proceeds to step 1918, described above.

If, however, the paginator 602, at step 1939, determines that the calculated global score is better than the score stored in the data table, then the paginator 602 proceeds to step 1942 where the paginator 602 replaces the entry stored in the data table with the new endpoint, calculated global score, current template 1106, and a back pointer to the current location. Next, the paginator 602 proceeds to step 1918, described above.

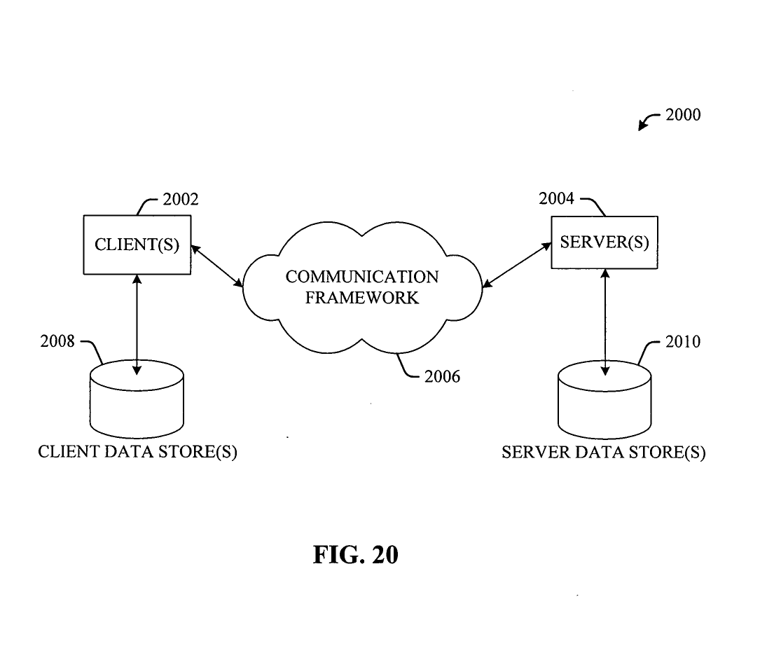

Referring now to FIG. 20, there is illustrated a schematic block diagram of an exemplary computer compilation system operable to execute the disclosed architecture. The system 2000 includes one or more client(s) 2002. The client(s) 2002 can be hardware and/or software (e.g., threads, processes, computing devices). The client(s) 2002 can house cookie(s) and/or associated contextual information by employing the features of the claimed subject matter, for example.

The system 2000 also includes one or more server(s) 2004. The server(s) 2004 can also be hardware and/or software (e.g., threads, processes, computing devices). The servers 2004 can house threads to perform transformations by employing features of the claimed subject matter, for example. One possible communication between a client 2002 and a server 2004 can be in the form of a data packet adapted to be transmitted between two or more computer processes. The data packet may include a cookie and/or associated contextual information, for example. The system 2000 includes a communication framework 2006 (e.g., a global communication network such as the Internet) that can be employed to facilitate communications between the client(s) 2002 and the server(s) 2004.

Communications can be facilitated via a wired (including optical fiber) and/or wireless technology. The client(s) 2002 are operatively connected to one or more client data store(s) 2008 that can be employed to store information local to the client(s) 2002 (e.g., cookie(s) and/or associated contextual information). Similarly, the server(s) 2004 are operatively connected to one or more server data store(s) 2010 that can be employed to store information local to the servers 2004.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates adapting a document layout that can be displayed at multiple sizes and dimensions with a wide variety of content, comprising:
an interface that receives a template, the template is a high level description of constraints for a document layout; and
a layout engine that interprets the template and determines where to place content in order to automatically produce a high quality layout.

2. The system of claim 1, further comprising a user interface that facilitates design and/or modification of the template by way of high level constraint parameters and provides for storage of the template.

3. The system of claim 2, the user interface is a graphical user interface (GUI).

4. The system of claim 1, the layout engine produces the high quality layout based upon at least one of semantic flow, brand identity, image and text correlation, and advertising themes.

5. The system of claim 1, the layout engine produces the high quality layout based upon the template, type(s) of content to be employed in the high quality layout, and display dimensions of the high quality layout.

6. The system of claim 5, further comprising an output device that displays the high quality layout, the display dimensions of the high quality layout are based upon the output device.

7. The system of claim 5, the display dimensions of the high quality layout are unknown when the template is created.

8. The system of claim 5, the type(s) of content to be employed in the high quality layout is unknown when the template is created.

9. The system of claim 1, further comprising a low level engine that applies the content to an adaptive grid-based layout based upon low level constraints, the layout engine determines where to position the content for the high quality layout and generates the low level constraints necessary for the low level engine to produce the high quality layout.

10. The system of claim 1, the layout engine determines where to place content based upon suitable locations for the content.

11. The system of claim 1, the document layout is a multi-level document layout with a top level and a bottom level, the layout engine determines where to place content in the bottom level based upon the position of content placed in the top level.

12. The system of claim 1, the content employed in the high quality layout is aggregated from multiple sources.

13. The system of claim 1, the layout engine employs an Extensible Stylesheet Language Transformation (XSLT) to translate the content from a source format the content is received.

14. A computer implemented methodology for arranging content to create a high quality layout, comprising:
choosing a template for a document layout, the template is defined in a high level language;
determining a display size for a document;
receiving content for the document;
employing the template and the display size for determining available locations for the content;
selecting from the available locations a high quality location for the content; and
creating a high quality layout for the document by arranging the content into the high quality location.

15. The method of claim 14, further comprising defining a template for a document in a high level language.

16. The method of claim 15, the display size of the document and the type of the content are unknown when the template is defined.

17. The method of claim 14, the determining available locations for the content is based at least in part upon locations of other content previously placed within the document.

18. The method of claim 14, the selecting a high quality location is based upon an algorithm, the algorithm is at least one of a best fit algorithm, a first fit algorithm and a first good fit algorithm.

19. The method of claim 14, the selecting a high quality location is based upon at least one of semantic flow, brand identity, image and text correlation, and advertising themes.

20. A computer implemented system that arranges content to create a high quality layout that can be displayed at multiple sizes and dimensions with a wide variety of content, comprising:
means for describing the constraints of a template for a document layout in a high level language;
means for determining a document display size;
means for receiving content for the document;
means for determining available locations for the content based upon the template and the display size for;
means for selecting from the available locations a high quality location for the content; and
means for producing a high quality layout for the document by placing the content into the high quality location.
